(19) United States
(12) Patent Application Publication
(10) Pub. No.: US 2026/0295393 A1
(43) Pub. Date: Oct. 1, 2026

(54) GAME SYSTEM, NON-TRANSITORY COMPUTER-READABLE RECORDING MEDIA, AND COMPUTER-IMPLEMENTED METHOD

(71) Applicant: NINTENDO CO., LTD., Kyoto-shi (JP)

(72) Inventors: Takamasa OKUDONO, Kyoto-shi (JP); Masayoshi MATSUOKA, Kyoto-shi (JP)

(21) Appl. No.: 19/631,882

(22) Filed: Mar. 27, 2026

(30) Foreign Application Priority Data
Mar. 28, 2025 (JP) 2025-056743

(51) Int. Cl. A63F 13/32; A63F 13/26; A63F 13/355

(52) U.S. Cl. CPC A63F 13/32; A63F 13/26; A63F 13/355

(57) ABSTRACT

A game system includes a first game apparatus and a second game apparatus. The first game apparatus receives input data of the second game apparatus, executes a game program using input data thereof and the received input data, generates a game image, sets a bit rate for encoding the generated game image based on the number of second game apparatuses, encodes the generated game image based on the set bit rate, and transmits the encoded game image to the second game apparatus. The second game apparatus receives the transmitted game image and shows the game image on a display thereof.

This nonprovisional application claims priority on Japanese Patent Application No. 2025-056743 filed with the Japan Patent Office on Mar. 28, 2025, the entire contents of which are hereby incorporated by reference.

### FIELD

The present disclosure relates, in particular, to a game system that executes a program, for example, of a multiple-player game, non-transitory computer-readable recording media having a program recorded thereon, and a control method.

### BACKGROUND AND SUMMARY

There has conventionally been a technique available, for example, for transmitting an image from a certain game apparatus to another game apparatus and showing the image at the another game apparatus.

There is room for improvement in encoding method in transmission of an image.

(Configuration 1) In one disclosed example embodiment, a game system includes a first game apparatus and a second game apparatus. The first game apparatus includes one or more processors and/or processing circuits and one or more memories storing instructions that cause the one or more processors to perform first operations including receiving input data of the second game apparatus, executing a game program using input data of the first game apparatus and the received input data, generating a game image, setting, based on the number of second game apparatuses a bit rate for encoding the generated game image, encoding of the generated game image based on the set bit rate, and transmitting the encoded game image to the second game apparatus. The second game apparatus includes one or more processors and one or more memories storing instructions that cause the one or more processors to perform second operations including receiving the transmitted game image, decoding the received game image, and displaying the decoded game image on a display of the second game apparatus.

(Configuration 2) In Configuration 1, the first operations may further include determining the number of the second game apparatuses at a start of a game. The setting may be performed based on the determined number of the second game apparatuses.

(Configuration 3) In Configuration 1, the setting may include setting an initial value of the bit rate based on the number of the second game apparatuses. In the encoding, the bit rate may be varied according to a communication state of the game image.

(Configuration 4) In Configuration 3, the encoding may further include varying the bit rate of a result of the encoding according to an amount of information of the game image.

(Configuration 5) In Configuration 3, the initial value may be set in common for a plurality of second game apparatuses. In the encoding, the bit rate may be varied for each of the second game apparatuses according to the communication state for each of the second game apparatuses. The encoding may include the encoding of the game image for each of the second game apparatuses based on the bit rate for each of the second game apparatuses.

(Configuration 6) In Configuration 1, the one or more memories of the first game apparatus may store the game program and a system program. The number or a maximum number of the second game apparatuses may be defined by the game program. The first operations may include setting an initial value of the bit rate based on the number or the maximum number defined by the game program currently being executed, by executing the system program.

(Configuration 7) In Configuration 1, the first operations may further include setting a value of a VBV buffer size in the encoding based on the number of the second game apparatuses.

(Configuration 8) In Configuration 7, the setting the value of the VBV buffer size may include setting an initial value of the VBV buffer size based on the number of the second game apparatuses. The value of the VBV buffer size may be changed for each of the second game apparatuses based on a bit rate of a result of the encoding for each of the second game apparatuses.

(Configuration 9) In one disclosed example embodiment, one or more non-transitory computer-readable storage media having stored therein instructions are provided. The instructions cause one or more processors of a game apparatus to perform operations including setting a bit rate for encoding based on the number of other game apparatuses, receiving input data of at least one of the other game apparatuses, executing a game program using input data of the game apparatus and the received input data, generating a game image, encoding of the generated game image based on the set bit rate, and transmitting the encoded game image to the at least one of the other game apparatuses.

(Configuration 10) In Configuration 9, the operations may further include determining the number of other game apparatuses at a start of a game. The setting may be performed based on the determined number of other game apparatuses.

(Configuration 11) In Configuration 9, the setting may be a setting of an initial value of the bit rate performed based on the number of other game apparatuses. In the encoding, the bit rate may be varied according to a communication state of the game image.

(Configuration 12) In Configuration 11, the encoding may further include varying the bit rate of a result of the performing encoding according to an amount of information of the game image.

(Configuration 13) In Configuration 11, the initial value may be set in common for a plurality of other game apparatuses. In the encoding, the bit rate may be varied for each of the other game apparatuses according to the communication state for each of the other game apparatuses. The encoding may include the encoding of the game image for each of the other game apparatuses based on the bit rate for each of the other game apparatuses.

(Configuration 14) In Configuration 9, the game apparatus may further include one or more memories storing the game program and a system program. The number or a maximum number of other game apparatuses may be defined by the game program. The operations may include setting an initial value of the bit rate based on the number or the maximum number defined by the game program currently being executed, by executing the system program.

(Configuration 15) In Configuration 9, the operations may further include setting a value of a VBV buffer size in the encoding based on the number of other game apparatuses.

(Configuration 16) In Configuration 15, the setting the value of the VBV buffer size may include setting an initial value of the VBV buffer size based on the number of other game apparatuses. The value of the VBV buffer size may be changed for each of the other game apparatuses based on a bit rate of a result of the encoding for each of the other game apparatuses.

(Configuration 17) In one disclosed example embodiment, a computer-implemented method for controlling a game apparatus includes determining the number of other game apparatuses, setting a bit rate for encoding based on the determined number, receiving input data of at least one of the other game apparatuses, executing a game program using input data of the game apparatus and the received input data, generating a game image, encoding of the generated game image based on the set bit rate, and transmitting the encoded game image to the at least one of the other game apparatuses.

(Configuration 18) In Configuration 17, the setting may include setting an initial value of the bit rate based on the number of other game apparatuses. In the encoding, the bit rate may be varied according to a communication state of the game image.

(Configuration 19) In Configuration 18, the encoding may further include varying the bit rate of a result of the encoding according to an amount of information of the game image.

(Configuration 20) In Configuration 18, the initial value may be set in common for a plurality of other game apparatuses. In the encoding, the bit rate may be varied for each of the other game apparatuses according to the communication state for each of the other game apparatuses. The encoding may include the encoding of the game image for each of the other game apparatuses based on the bit rate for each of the other game apparatuses.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing of a schematic diagram showing an exemplary configuration of an entire system 1 including an information processing system according to an embodiment.

FIG. 2 shows an exemplary illustrative non-limiting drawing of a schematic diagram showing another exemplary configuration of an entire system 2 including the information processing system according to the embodiment.

FIGS. 3A and 3B each show an exemplary illustrative non-limiting drawing of a schematic diagram of a flow of game processing in the information processing system according to the embodiment.

FIG. 4 shows an exemplary illustrative non-limiting drawing of a schematic diagram showing an exemplary hardware configuration of a game apparatus 100 according to the embodiment.

FIG. 5 shows an exemplary illustrative non-limiting drawing illustrating an exemplary program stored in a flash memory 106 of a game apparatus (host) 100-1 according to the embodiment.

FIGS. 6A and 6B each show an exemplary illustrative non-limiting drawing illustrating data stored in a DRAM 108 of the game apparatus according to the embodiment.

FIG. 7 shows an exemplary illustrative non-limiting drawing of a flowchart illustrating game processing in the game apparatus (host) according to the embodiment.

FIGS. 8A and 8B each show an exemplary illustrative non-limiting drawing illustrating a menu screen according to the embodiment.

FIG. 9 shows an exemplary illustrative non-limiting drawing of a sub routine flowchart of member recruitment processing according to the embodiment.

FIG. 10 shows an exemplary illustrative non-limiting drawing illustrating an exemplary connection check screen according to the embodiment.

FIG. 11 shows an exemplary illustrative non-limiting drawing of a flowchart illustrating mode storing processing in a game sharing function according to the embodiment.

FIG. 12 shows an exemplary illustrative non-limiting drawing of a flowchart illustrating streaming start processing according to the embodiment.

FIG. 13 shows an exemplary illustrative non-limiting drawing of a sub routine flowchart of streaming processing according to the embodiment.

FIG. 14 shows an exemplary illustrative non-limiting drawing of a sub routine flowchart of target bit rate setting processing according to the embodiment.

FIG. 15 shows an exemplary illustrative non-limiting drawing of another sub routine flowchart of the target bit rate setting processing according to the embodiment.

FIGS. 16A and 16B each show an exemplary illustrative non-limiting drawing illustrating change of a VBV buffer size according to the embodiment.

FIG. 17 shows an exemplary illustrative non-limiting drawing of a sub routine flowchart of processing for transmitting antenna level related information to a guest G (i) according to the embodiment.

FIG. 18 shows an exemplary illustrative non-limiting drawing of another sub routine flowchart of the processing for transmitting the antenna level related information to guest G (i) according to the embodiment.

FIG. 19 shows an exemplary illustrative non-limiting drawing of a flowchart illustrating game processing in a game apparatus (guest) according to the embodiment.

FIG. 20 shows an exemplary illustrative non-limiting drawing of a sub routine flowchart of connection request processing in the game apparatus (guest) according to the embodiment.

FIG. 21 shows an exemplary illustrative non-limiting drawing illustrating an exemplary connection request check screen according to the embodiment.

FIG. 22 shows an exemplary illustrative non-limiting drawing of a sub routine flowchart of antenna level calculation and display processing according to the embodiment.

FIG. 23 shows an exemplary illustrative non-limiting drawing of another sub routine flowchart of the antenna level calculation and display processing according to the embodiment.

FIG. 24 shows an exemplary illustrative non-limiting drawing illustrating a screen of a display 104 of the game apparatus according to the embodiment.

### DETAILED DESCRIPTION OF NON-LIMITING EXAMPLE EMBODIMENTS

An embodiment will be described in detail with reference to the drawings. The same or corresponding elements in the drawings have the same reference characters allotted and description thereof will not be repeated.

### A. Exemplary System Configuration

An exemplary configuration of a game system representing an exemplary information processing system according to the present embodiment will initially be described. The game system is an exemplary information processing system, and the information processing system may be a system where a game is not executed. For example, in a phrase "a processor of an information processing system," the processor may mean, for example, one or more processors within a single apparatus such as a main body apparatus, or may mean at least one or all of one or more processors included in a plurality of apparatuses.

FIG. 1 is a schematic diagram showing an exemplary configuration of an entire system 1 including an information processing system according to the present embodiment. A game apparatus 100 will be described as an exemplary information processing system. The information processing system may be, for example, a personal computer, a smartphone, a tablet, a wearable terminal, a smart television, a server, or the like.

The term "information processing system" encompasses at least both of a configuration in which necessary components are mounted on a single housing and a configuration in which necessary components are mounted as being distributed among a plurality of housings.

Referring to FIG. 1, entire system 1 includes one or more game apparatuses 100. FIG. 1 shows entire system 1 including four game apparatuses 100 by way of example. When each of a plurality of game apparatuses 100 should be specified in the description below, a sub number will be given for distinction (for example, game apparatuses 100-1, 100-2, 100-3, and 100-4 shown in FIG. 1). An example is shown in which a game apparatus (host) 100-1 is connected to other game apparatuses (guest) 100-2, 100-3, and 100-4 by local wireless communication by way of example of a network. Communication using IEEE 802.11 standards, communication which is improvement of IEEE 802.11 standards, Bluetooth®, ZigBee®, or the like can be employed as a specific example of local wireless communication.

In entire system 1, game apparatus 100 can join one or more player groups (which will also be abbreviated as a "group" below). In order for game apparatus 100 to join at least one group, an account of a user who uses game apparatus 100 or identification information or the like of game apparatus 100 may be used.

Certain game apparatus 100 may be permitted to simultaneously belong only to a single group or may be permitted to simultaneously belong to a plurality of groups. Processing in an example where a game apparatus belongs to one group will be described below by way of example. An upper limit may be set for the number of game apparatuses 100 permitted to belong to each group.

A game program 240 is stored in game apparatus (host) 100-1, and by executing game program 240, the game apparatus (host) can communicate with one or more other game apparatuses 100 belonging to a group connected by local wireless communication to perform game processing.

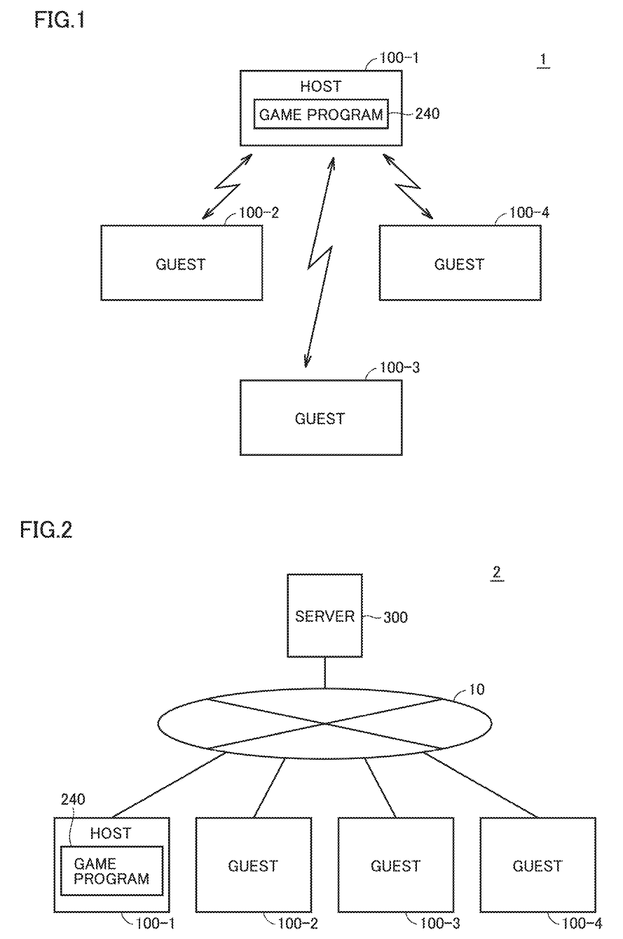

FIG. 2 is a schematic diagram showing another exemplary configuration of an entire system 2 including the information processing system according to the present embodiment. FIG. 2 shows an exemplary configuration in which, in entire system 2, four game apparatuses 100-1 to 100-4 are connected by on-line connection over an Internet communication network 10 by way of another example of the network. Each game apparatus 100 exchanges data over network 10. In entire system 2, a method of communication in which each game apparatus 100 is connected to network 10 may be wired communication or wireless communication. Entire system 2 may further include a management server 300. Game apparatuses 100 may communicate with each other with management server 300 being interposed or may directly (peer to peer) communicate with each other without management server 300 being interposed.

For example, in an example where game program 240 supports play by multiple players, game apparatus (host) 100-1 communicates with other game apparatuses (guest) 100-2, 100-3, and 100-4. Game apparatus (host) 100-1 executes game program 240 that supports play by multiple players, based on operation input from a player thereof and other game apparatuses.

"Play by multiple players" herein means simultaneous play of the same game by a plurality of players (users). Alternatively, "play by multiple players" means participation of a plurality of players (users) in the same player group. Further alternatively, "play by multiple players" means execution in each game apparatus 100, of game program 240 based not only on information on operation by a player of each game apparatus 100 but also on information from other game apparatuses 100.

In the present embodiment, game apparatus (host) 100-1 executes a game program and generates a game image based on operation data thereof and operation data received from game apparatuses (guest) 100-2, 100-3, and 100-4 and transmits the generated game image to game apparatuses (guest) 100-2, 100-3, and 100-4. Game apparatuses (guest) 100-2, 100-3, and 100-4 each show the received game image on a display thereof.

All game apparatuses 100 may hold game program 240 in advance with any method.

Management server 300 is responsible for management necessary for one or more game apparatuses 100. For example, management server 300 may make determination as to permission of participation of game apparatus 100 or a user. Entire system 2 may include a plurality of management servers 300. Management server 300 may be a virtual server. Management server 300 may be implemented by a plurality of server apparatuses.

Participation in a group may be on a user basis or an account basis. One or more accounts may be registered in a single game apparatus 100. In this case, a user who uses game apparatus 100 may select an account each time. Alternatively, the user who uses game apparatus 100 may operate game apparatus 100 to access management server 300 or the like and perform processing for log-in or the like, so that the account is dynamically associated with game apparatus 100.

### B. Flow of Game Processing in Game Apparatus 100

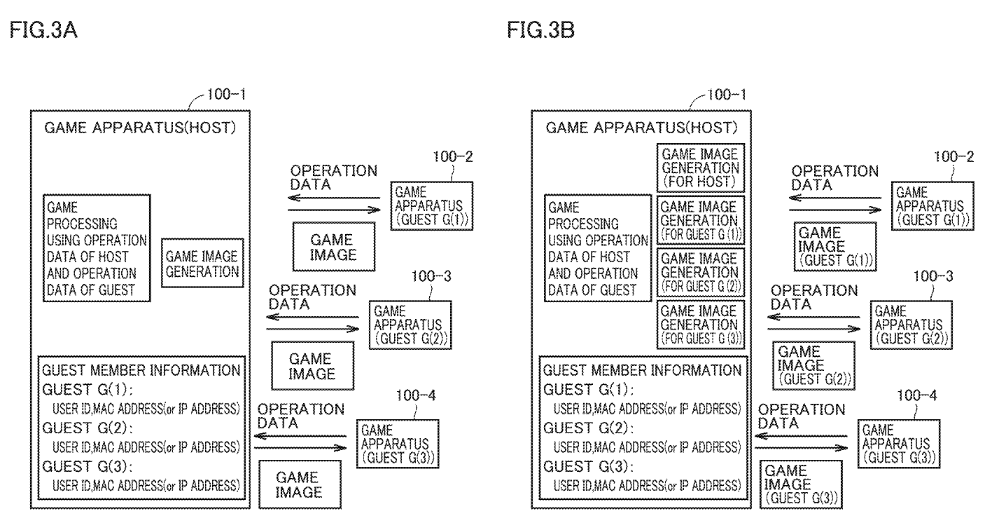

FIGS. 3A and 3B are each a schematic diagram of a flow of game processing in the information processing system according to the present embodiment. FIG. 3A shows the flow of game processing in a common image mode in the information processing system by way of example. As described previously, in the present embodiment, game apparatus (host) 100-1 generates a game image. The common image mode refers to a mode in which a game image common between the game apparatus (host) and the game apparatus (guest) is generated. Game apparatus (host) 100-1 is provided with guest member information on a guest member included in a group. By way of example, the game apparatus (host) is provided with information corresponding to guests G (1) to G (3) (which will also collectively be referred to as a guest G (i); for example, i being 1 to 3). The guest member information includes a user ID and a MAC address (or an IP address) corresponding to each of guests G (1) to G (3). Game apparatus (host) 100-1 specifies game apparatuses 100-2, 100-3, and 100-4 corresponding to respective guests G (1) to G (3) in accordance with the guest member information and communicates data. In the present embodiment, game apparatus (host) 100-1 receives operation data from game apparatuses 100-2, 100-3, and 100-4 corresponding to respective guests G (1) to G (3). Game apparatus (host) 100-1 performs game processing using the operation data thereof and operation data of the game apparatus (guest G (i)). Game apparatus (host) 100-1 generates a game image (the game image common between the game apparatus (host) and the game apparatus (guest)) through the game processing and transmits the game image to game apparatuses 100-2, 100-3, and 100-4 corresponding to respective guests G (1) to G (3).

FIG. 3B shows the flow of the game processing in an individual image mode in the information processing system by way of example. The individual image mode refers to a mode in which game apparatus (host) 100-1 generates game images different between the game apparatus (host) and the game apparatus (guest). In the individual image mode, as compared with the game processing in the common image mode, processing for generating the game image is different. For example, a game image for the host of game apparatus (host) 100-1, a game image for guest G (1) of game apparatus 100-2, a game image for guest G (2) of game apparatus 100-3, and a game image for guest G (3) of game apparatus 100-4 are independently generated. Game apparatus (host) 100-1 transmits game images for guests G (1) to G (3) to game apparatuses 100-2, 100-3, and 100-4 corresponding to guests G (1) to G (3), respectively.

### C. Exemplary Hardware Configuration of Game Apparatus 100

An exemplary hardware configuration of game apparatus 100 according to the present embodiment will now be described.

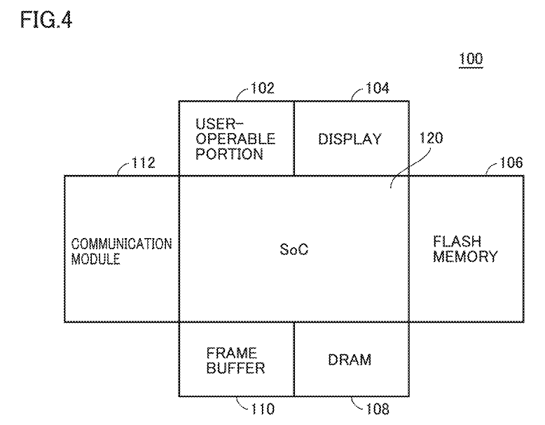

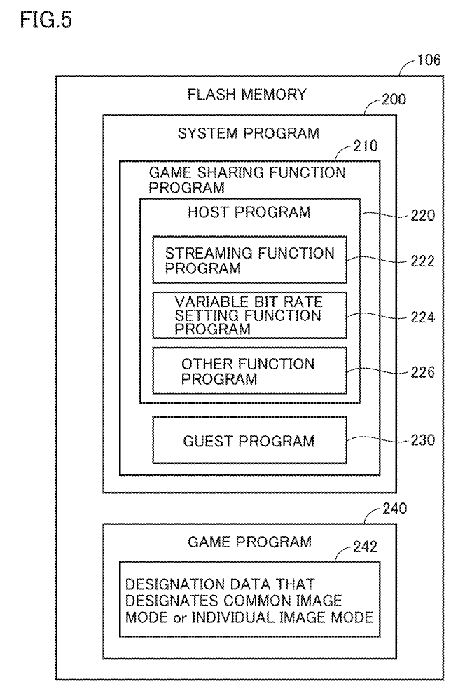

FIG. 4 is a schematic diagram showing the exemplary hardware configuration of game apparatus 100 according to the present embodiment. Game apparatus 100 is a kind of computer. Referring to FIG. 4, game apparatus 100 includes, for example, a user-operable portion 102, a display 104, a flash memory 106, a DRAM 108, a frame buffer 110, a communication module 112, and a system on chip (SoC) 120.

SoC 120 is a processor and responsible for processing to be performed in game apparatus 100. SoC 120 includes, for example, at least one of a central processing unit (CPU), a graphics processing unit (GPU), a buffer, and the like. For example, SoC 120 includes a VBV buffer to be used in encoding processing (the VBV buffer may be secured in a main memory or the like outside SoC 120). The VBV buffer is provided for each guest G (i). The CPU, the GPU, the buffer, and the like may be mounted independently of one another, rather than being mounted on a single substrate. Other than SoC 120, hardwired circuitry such as an application specific integrated circuit (ASIC) or a field programmable gate array (FPGA) may be included, and such circuitry may perform some processing. SoC 120 may include a plurality of CPUs and a plurality of GPUs, or may include a plurality of cores.

Flash memory 106 is a non-volatile storage medium, and it is a memory mainly used for storage of various types of data to be held in game apparatus 100. A system program 200 which will be described later and game program 240 are stored in flash memory 106. System program 200 includes computer-readable instructions for such basic processing as hardware control of game apparatus 100 and provision of a program execution environment and includes a program for a system application. Game program 240 includes computer-readable instructions for execution of a game.

Dynamic random access memory (DRAM) 108 is a volatile storage medium and it is a memory used mainly for temporary storage of various types of data to be used in information processing. The "memory" may include at least a flash memory and a DRAM, and may include other storage media.

Frame buffer 110 temporarily holds image data to be shown on display 104. SoC 120 encodes image data for each frame held, for example, in frame buffer 110, with a hardware encoder or a software encoder, and transmits the encoded image data to each game apparatus (guest) 100 via communication module 112. For example, SoC 120 sets a bit rate for encoding based on the number of game apparatuses (guest), encodes the generated game image based on the set bit rate, and transmits the encoded game image to the game apparatus (guest). The game apparatus (guest) receives the transmitted game image and shows the game image on the display thereof.

User-operable portion 102 accepts a user operation. User-operable portion 102 includes, for example, a keyboard, a mouse, a game controller, a button, a cross-shaped key, a joystick, a touch panel, a motion sensor, or the like. User-operable portion 102 may be an interface with an apparatus (for example, a game controller) that accepts a user operation. The apparatus that accepts a user operation may be located outside game apparatus 100. User-operable portion 102 may be located at a main body portion of game apparatus 100, may be a controller attachable to or removable from the main body portion of game apparatus 100, or a controller separate from game apparatus 100.

Communication module 112 transmits and receives data to and from another game apparatus 100 or the like. Communication module 112 may be connected to network 10 by wired connection or wireless connection. For example, universal serial bus (USB) connection, parallel connection, or the like may be adopted as wired connection. For example, Bluetooth®, ZigBee®, wireless LAN (IEEE 802.11 standard), or the like may be adopted as wireless connection.

Display 104 is, for example, a liquid crystal display (LCD), an organic EL display, a television display, a monitor, or the like.

For example, game apparatus (host) 100-1 receives operation data of user-operable portions 102 of other game apparatuses (guest) 100-2, 100-3, and 100-4, executes game program 240 using the operation data of user-operable portion 102 thereof and the received operation data, generates the game image, encodes the generated game image in a manner varied in bit rate, and transmits the encoded game image to other game apparatuses (guest) 100-2, 100-3, and 100-4. The information processing system determines quality of display of the game image at game apparatuses (guest) 100-2, 100-3, and 100-4 based on at least one of a communication state in communication of the game image and the bit rate for encoding, and has an icon representing display quality shown on the displays of game apparatuses (guest) 100-2, 100-3, and 100-4, together with the game image.

### D. Program Configuration

FIG. 5 is a diagram illustrating an exemplary program stored in flash memory 106 of game apparatus (host) 100-1 according to the present embodiment. Referring to FIG. 5, system program 200 and game program 240 are stored in flash memory 106.

System program 200 includes a game sharing function program 210 that performs a game sharing function in which one game apparatus 100 (host apparatus) executes game program 240 and plays with another game apparatus 100 (guest apparatus), a game (which is called shared play below) in accordance with game program 240. Game sharing function program 210 includes a host program 220 for performing a function of game apparatus 100 to be the host in performing the game sharing function and a guest program 230 for performing a function of game apparatus 100 to be the guest in performing the game sharing function. Host program 220 includes a streaming function program 222 for performing processing for streamed transmission of the game image from game apparatus 100 to be the host to game apparatus 100 to be the guest, a variable bit rate setting function program 224 for variably setting a bit rate in performing streaming processing, and an other function program 226 for performing other functions.

Guest program 230 allows in game apparatus 100 to be the guest, data transmission and reception to and from game apparatus 100 to be the host to thereby perform the game sharing function in the game processing based on game program 240, and includes a function to receive streamed transmission of the game image transmitted from game apparatus 100 to be the host to show the game image on the display. For example, each of game apparatuses (guest G (i)) 100-2, 100-3, and 100-4 can perform the game processing in accordance with the game sharing function with game apparatus (host) 100-1 by executing the guest program stored in flash memory 106. Guest program 230 may be stored in advance in flash memory 106 of each of game apparatuses (guest G (i)) 100-2, 100-3, and 100-4, or may be distributed, for example, from game apparatus 100 to be the host and stored in flash memory 106 of game apparatus 100 to be the guest.

Though a configuration in which one game program 240 is provided is described in the present embodiment, without being limited as such, a plurality of game programs that perform the game sharing function may be provided. Game program 240 includes designation data 242 that designates the common image mode or the individual image mode. By referring to designation data 242 in execution of game program 240, game processing based on one of the modes is performed. Though an example in which the common image mode or the individual image mode is designated in advance in accordance with the game program is described in the present embodiment, the user may select the common image mode or the individual image mode. In the present embodiment, a program similar to system program 200 stored in flash memory 106 of game apparatus (host) 100-1 is also stored in flash memories 106 of game apparatuses (guest) 100-2, 100-3, and 100-4.

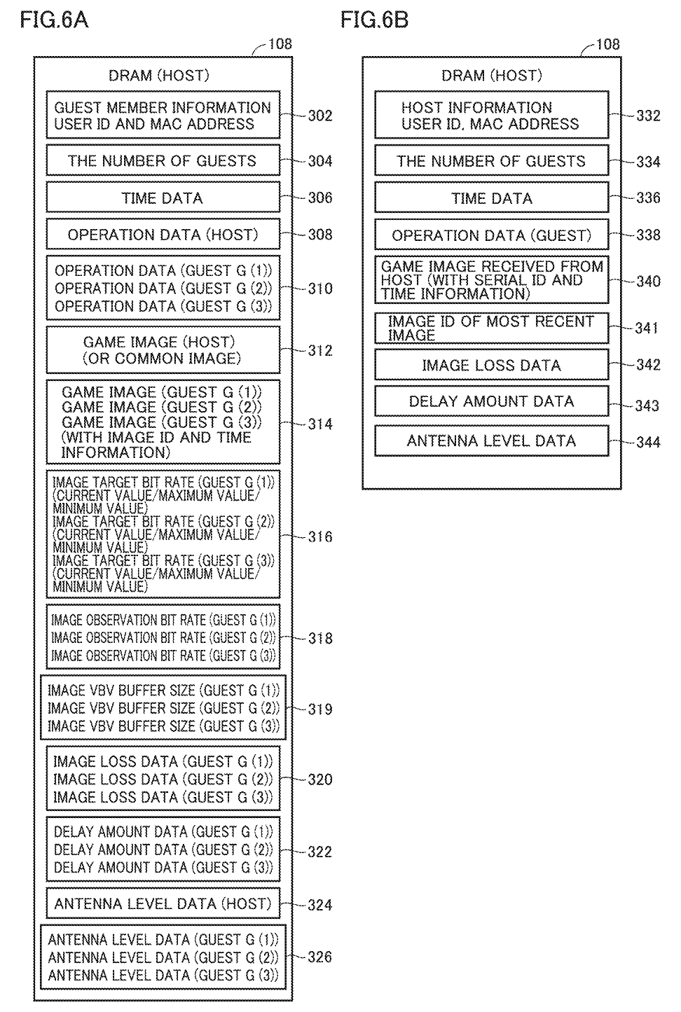

FIGS. 6A and 6B are each a diagram illustrating data stored in DRAM 108 of the game apparatus according to the present embodiment. FIG. 6A shows data in DRAM 108 at a side of game apparatus (host) 100-1 by way of example. DRAM 108 at the side of game apparatus (host) 101 includes guest member information 302, the number of guests 304, time data 306, operation data (host) 308, operation data (each guest G (i)) 310, a game image (host) (or common image) 312, a game image (each guest G (i)) 314, an image target bit rate (each guest G (i)) 316, an image observation bit rate (each guest G (i)) 318, an image VBV buffer size (each guest G (i)) 319, image loss data (each guest G (i)) 320, delay amount data (each guest G (i)) 322, antenna level data (host) 324, and antenna level data (each guest G (i)) 326.

Guest member information 302 is information on a user who joins a group as the guest in the game processing. By way of example, guest member information 302 includes a user ID and a MAC address associated with the user ID. The information is stored in accordance with the number of guests who join the group. For example, the information may be collected and stored in member recruitment processing which will be described later.

The number of guests 304 refers to the number of users who join the group as the guest in the game processing.

Time data 306 is data on time and may be used in processing for synchronization with another game apparatus (guest) or processing for calculating an amount of delay.

Operation data (host) 308 is data in accordance with operations on user-operable portion 102 at the side of game apparatus (host) 100-1 which is a subject apparatus.

Operation data (guest G (i)) 310 refers to data in accordance with operations on user-operable portions 102 of other game apparatuses (guest) 100-2, 100-3, and 100-4 received from other game apparatuses (guest) 100-2, 100-3, and 100-4.

Game image (host) 312 is image data for the host generated based on the game processing.

Game image (guest G (i)) 314 is image data for the guest generated based on the game processing. The image data is transmitted with an image ID being associated therewith. The image ID may be a serial ID of the image which is incremented in transmission of the image, or a time stamp may be used as the ID. Since the image data for the host and the image data for the guest are in common in the game processing in the common image mode, they do not have to individually be generated. The game image temporarily stored in DRAM 108 may be transferred to frame buffer 110. In the present embodiment, the game image stored in frame buffer 110 is encoded in a manner varied in bit rate and transmitted to another game apparatus (guest G (i)) 100. Though game image (host) 312 for the host and game image 314 for the guest are different from each other in the game processing in the individual image mode, game image (host) 312 for the host and game image 314 for the guest are in common in the game processing in the common image mode.

Image target bit rate (guest G (i)) 316 refers to an amount of data per one second of the encoded image data and encoding is performed to achieve a target bit rate (aiming at the target bit rate). The data includes a current value, a maximum value, and a minimum value of the target bit rate. In the present embodiment, the current value of the target bit rate is variably set based on variable bit rate setting function program 224 to variably set the target bit rate. This target bit rate may be called a set bit rate. Though an example where the target bit rate is variably set is described, the target bit rate may be set as being fixed.

Image observation bit rate (guest G (i)) 318 is data obtained by measurement of an amount of data (bit rate) per one second of the image data obtained as a result of encoding. For example, the image observation bit rate can be calculated by measuring the amount of data outputted along a time axis and dividing the amount of data by a measurement time period. Observation bit rate (guest G (i)) 318 may be used for setting the target bit rate.

Image video buffer verifier (VBV) buffer size (guest G (i)) 319 is data that defines the VBV buffer size in encoding the image data. SoC 120 secures a VBV buffer in accordance with the VBV buffer size and performs processing for encoding the image data for each guest G (i) stored in frame buffer 110. The image data subjected to the encoding processing is transmitted to each game apparatus (guest G (i)) via communication module 112. For example, an amount of information (sufficiency) that remains in accordance with the VBV buffer size can be observed to control quantization and to change the bit rate. The encoding processing includes a plurality of encoding modes, and an appropriate encoding mode is selected by optimization processing in accordance with the VBV buffer size. In the present embodiment, the VBV buffer is provided for each guest G (i) and the bit rate is changed for each guest G (i).

Image loss data (guest G (i)) 320 is data indicating loss of the image at the game apparatus (guest) (failure in delivery to the guest, of the game image transmitted by the host). For example, the image loss data may include the image ID associated with the game image preceding or subsequent to the lost image, or may include the image ID of the lost image calculated from the image ID associated with the game image preceding or subsequent to the lost image. The host specifies occurrence of loss and the lost image based on the image ID (the lost image is sent again). Image loss data (guest G (i)) 320 may be used for setting the target bit rate or in processing for generating antenna level data.

Delay amount data (guest G (i)) 322 represents a delay time period of data transmitted from the game apparatus (host) to another game apparatus (guest). Delay amount data (guest G (i)) 322 may be used for setting the target bit rate.

Antenna level data (host) 324 is data to be used in showing an icon representing quality of display at the game apparatus (guest), of the image data transmitted for display at display 104 of the game apparatus (host). For example, in a case of antenna level data L1, an icon representing one antenna is shown. In a case of antenna level data L2, an icon representing two antennas is shown. In a case of antenna level data L3, an icon representing three antennas is shown. Though three icons representing the number of antennas are described in the present embodiment, the number of antennas is not limited thereto. As more antenna levels are provided, an icon representing antennas accordingly increased in number may be shown.

Antenna level data (guest G (i)) 326 is data to be used for determination of antenna level data (host) 324. For example, antenna level data (guest G (i)) 326 is data associated with image quality at another game apparatus (guest), of the image data transmitted from the game apparatus (host) to that another game apparatus (guest).

FIG. 6B shows data in DRAM 108 at the side of each of game apparatuses (guest G (i)) 100-2, 100-3, and 100-4 by way of example. DRAM 108 at the side of the guest includes host information 332, the number of guests 334, time data 336, operation data (guest) 338, a game image 340 received from the host, an image ID 341 of the most recent image, image loss data 342, delay amount data 343, and antenna level data 344.

Host information 332 is information on a user who joins a group as the host in the game processing. For example, host information 332 includes a user ID and a MAC address associated with the user ID. The information is stored in accordance with the host who joins the group. For example, the information may be collected and stored in member recruitment processing which will be described later.

The number of guests 334 refers to the number of users who join the group as the guest in the game processing.

Time data 336 is data on time and may be used in processing for synchronization with a game apparatus (host) or processing for calculating an amount of delay.

Operation data (guest) 338 is data in accordance with operations on user-operable portion 102 at the side of the game apparatus (guest G (i)) which is a subject apparatus.

Game image 340 received from the host is game image 314 for guest G (i) that is generated by the host based on the game processing described with reference to FIG. 6A and transmitted from the host to the guest. In the game processing in the common image mode, game image 340 is the common image and the same as game image (host) 312. The image ID of the image and time information are added to the image data in association.

Image ID 341 of the most recent image is data on the image ID associated with the game image most recently received from the host.

Image loss data 342 is data indicating loss of the image at the game apparatus (guest). For example, the image loss data includes data on the image ID corresponding to the lost image. Image loss data 342 can be specified based on comparison between image ID 341 of the most recent image and the image ID associated with the game image currently received from the host. For example, when image ID 341 of the most recent image is checked and the image IDs sequentially arrive, there is no image loss. When image ID 341 of the most recent image is checked and the image IDs are not consecutive but there is an image ID missing, on the other hand, occurrence of loss of the image corresponding to the missing image ID can be specified. Game apparatus (guest G (i)) 100-2, 100-3, or 100-4 transmits image loss data 342 corresponding to the missing image ID to game apparatus (host) 100-1. Game apparatus (host) 100-1 stores in DRAM 108, image loss data 342 corresponding to each guest G (i) as image loss data 320.

Delay amount data 343 is data on an amount of delay based on time information added to the received image data and current time data 336. For example, the amount of delay may be calculated based on a difference between the time information added to the image data and current time data 336.

Antenna level data 344 is data to be used for showing an icon representing quality of display of received image data for display at display 104 of the game apparatus (guest). For example, in the case of antenna level data L1, an icon representing one antenna is shown. In the case of antenna level data L2, an icon representing two antennas is shown. In the case of antenna level data L3, an icon representing three antennas is shown. Though three icons representing the number of antennas are described in the present embodiment, the number of antennas is not limited thereto. As more antenna levels are provided, an icon representing antennas accordingly increased in number may be shown. Antenna level data 344 may be, for example, data calculated based on antenna level calculation and display processing which will be described later.

### E. Process Flow

Several types of processing in the embodiment will be described below. The processing may include other types of processing or does not have to include a part of processing. The order of processing is by way of example. For example, a plurality of types of processing may be performed simultaneously, or some processing may be performed in a reverse order. Though processing is described as being divided for the sake of convenience of description, it may be integrated.

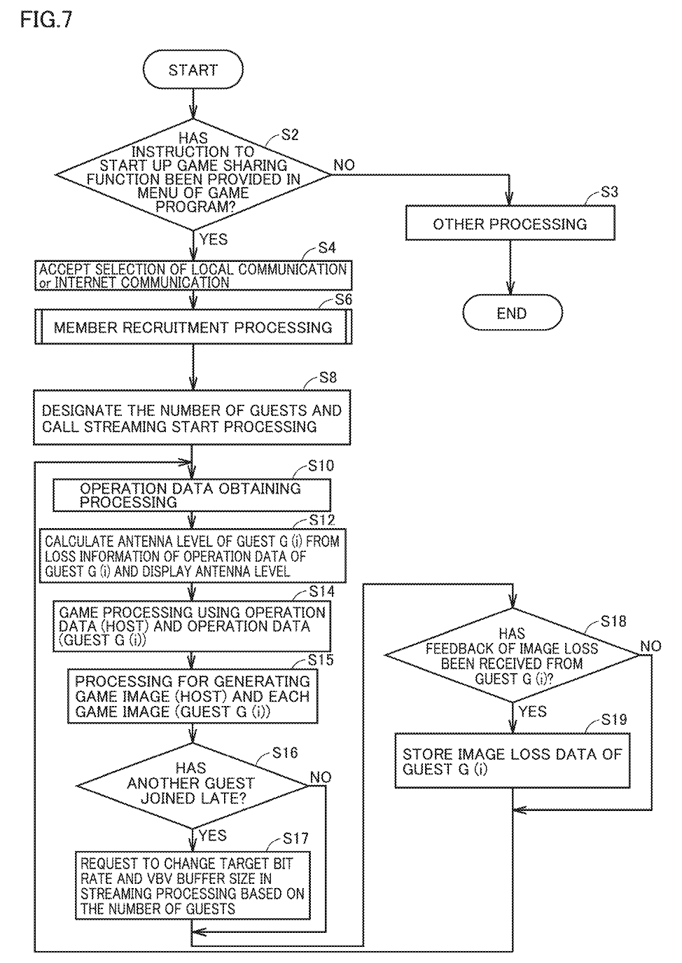

FIG. 7 is a flowchart illustrating the game processing in the game apparatus (host) according to the present embodiment. A processing procedure shown in FIG. 7 is realized by reading and execution by SoC 120 of game apparatus (host) 100-1, of game program 240 stored in flash memory 106.

Referring to FIG. 7, SoC 120 determines whether or not an instruction to start up the game sharing function has been provided in a menu screen of the game program (step S2). In step S2, the common image mode or the individual image mode is designated in the system program.

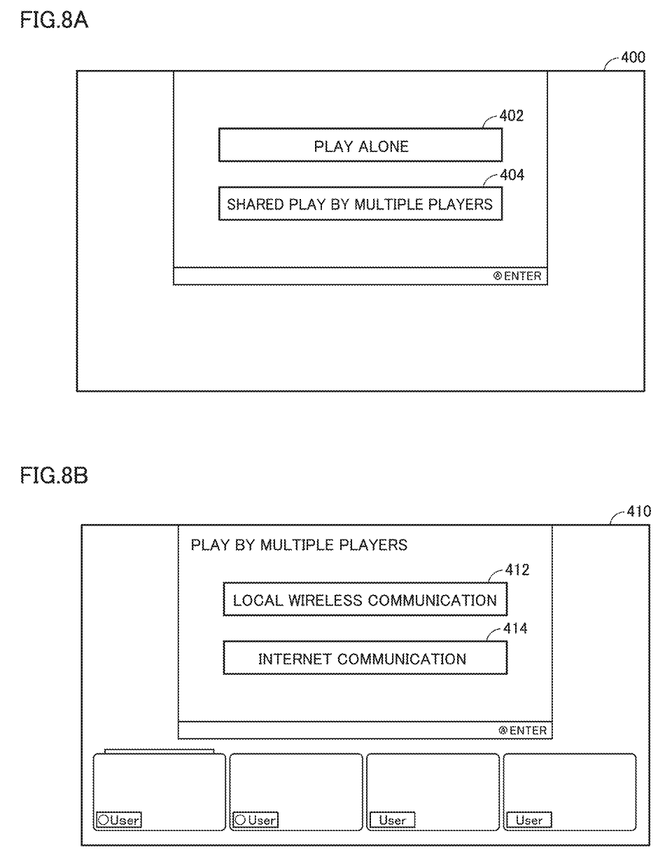

FIGS. 8A and 8B are each a diagram illustrating the menu screen according to the present embodiment. FIG. 8A shows an example where a menu screen 400 is shown on display 104. Menu screen 400 is provided with a "play alone" icon 402 and a "shared play by multiple players" icon 404 for accepting selective input by the user. The user can select one icon by operating user-operable portion 102. For example, SoC 120 may determine that the user has indicated start-up of the game sharing function when the user selects "shared play by multiple players" icon 404.

FIG. 8B shows an example where another menu screen 410 is shown at display 104. Menu screen 410 is provided with a "local wireless communication" icon 412 and an "Internet communication" icon 414 for accepting selective input by the user. The user can select one icon by operating user-operable portion 102. For example, SoC 120 may determine that the user has indicated start-up of the game sharing function in local wireless communication when the user selects "local wireless communication" icon 412. For example, game apparatus (host) 100-1 operates to construct the entire system in which it is connected to another game apparatus (guest) 100-2 or the like by local wireless communication as described with reference to FIG. 1.

SoC 120 may determine that the user has indicated start-up of the game sharing function in the Internet communication when the user selects "Internet communication" icon 414. For example, game apparatus (host) 100-1 operates to construct the entire system in which the plurality of game apparatuses 100 are connected by on-line connection over Internet communication network 10 as described with reference to FIG. 2.

Referring again to FIG. 7, when SoC 120 determines in step S2 that the instruction to start up the game sharing function has been provided (YES in step S2), it accepts selection of local wireless communication or the Internet communication (step S4). For example, as described with reference to FIG. 8B, selective input from the user for communication is accepted. The system program is notified of the selected communication method in step S4.

When SoC 120 determines in step S2 that the instruction to start up the game sharing function has not been provided (NO in step S2), on the other hand, it performs other processing (step S3). The process then ends (end). For example, when "play alone" icon 402 is selected in FIG. 8A, game processing by one person based on game program 240 may be performed without the game sharing function being started up.

SoC 120 then performs member recruitment processing (step S6). For example, in the member recruitment processing, members of the group may be recruited until the number of members reaches an upper limit value of the number of guests supported by the game program, or the member recruitment processing may be suspended also when the number of guests does not reach the upper limit value.

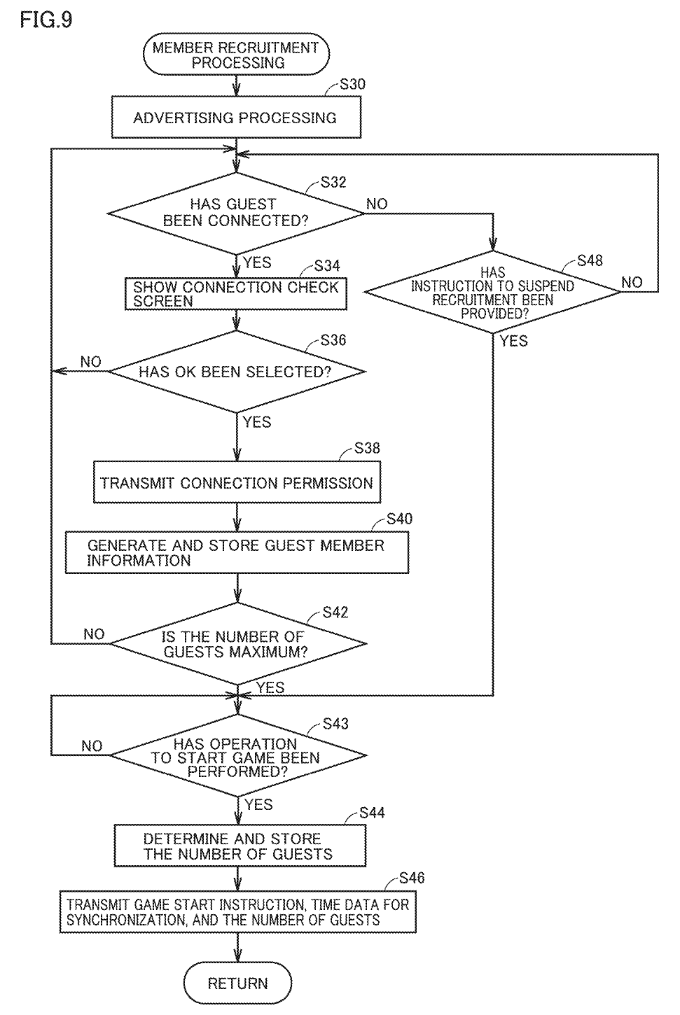

FIG. 9 is a sub routine flowchart of the member recruitment processing according to the present embodiment. Though there are various methods for the member recruitment processing, a case of local wireless communication will be described with reference to FIG. 9 by way of example. SoC 120 of game apparatus (host) 100-1 performs advertising processing (step S30). Game apparatus (host) 100-1 waits for connection of another game apparatus (guest G) 100-2 or the like by the guest through the advertising processing.

SoC 120 then determines whether or not the guest has been connected (step S32).

When SoC 120 determines in step S32 that the guest has been connected (YES in step S32), it has a connection check screen shown at display 104 for selection as to whether or not connection is permitted in accordance with information on the guest.

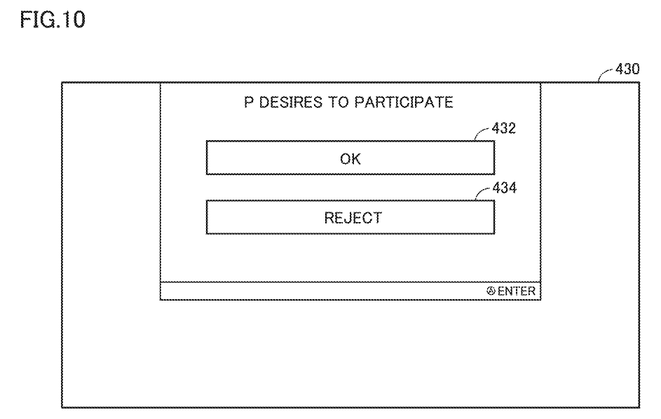

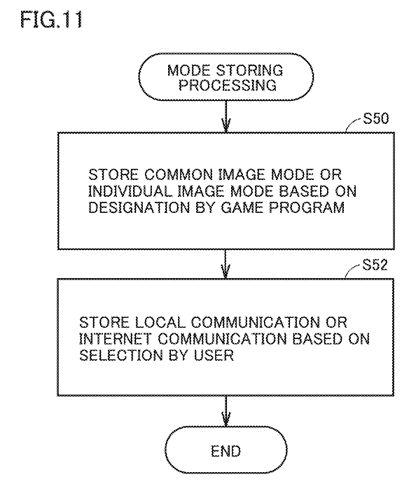

FIG. 10 is a diagram illustrating an exemplary connection check screen according to the present embodiment. Referring to FIG. 10, a connection check screen 430 is provided, for example, with an "OK" button 432 for permitting connection together with comments "P desires to participate" and a "reject" button 434 for rejecting connection. For example, when the user who is the host selects "OK" button 432 in connection check screen 430, connection of game apparatus 100 of the guest (for example, P) who desires connection is permitted. When the user selects "reject" button 434 in connection check screen 430, on the other hand, connection of game apparatus 100 of the guest (for example, P) who desires connection is rejected.

Referring again to FIG. 9, SoC 120 determines whether or not the user who is the host has selected "OK" in connection check screen 430 (step S36).

When SoC 120 determines in step S36 that the user who is the host has selected "OK" in connection check screen 430 (YES in step S36), it transmits connection permission to game apparatus 100 of the guest (for example, P) who desires connection (step S38). For example, connection permission includes host information. The host information is data including the user ID and MAC address data of the game apparatus which is the host. Game apparatus (guest) 100 that has received connection permission stores host information 332 in DRAM 108 based on the data.

SoC 120 then generates and stores the guest member information (step S40). For example, SoC 120 generates and registers necessary information as guest member information 302 in DRAM (host) 108. By way of example, SoC 120 stores the user ID of the guest who desires connection and the MAC address associated with the user ID. The user ID and the MAC address are data obtained from game apparatus 100 of the guest who desires connection in the advertising processing.

SoC 120 then determines whether or not the number of guests 304 has attained to maximum (upper limit value) of the number of guests supported by the game program (step S42).

When SoC 120 determines in step S42 that the number of guests 304 has not attained to the maximum (upper limit value) of the number of guests supported by the game program (NO in step S42), the process returns to step S32 and processing above is repeated.

When SoC 120 determines in step S42 that the number of guests 304 has attained to the maximum (upper limit value) of the number of guests supported by the game program (YES in step S42), on the other hand, it determines whether or not an operation to start the game has been performed (step S43). For example, when the user who is the host provides operation input to start the game, the SoC determines that the operation to start the game has been performed.

When the operation to start the game has not been performed in step S43 (NO in step S43), SoC 120 maintains that state. Alternatively, when the operation to start the game is suspended, return to the initial menu screen may be made.

When SoC 120 determines in step S43 that the operation to start the game has been performed (YES in step S43), on the other hand, it determines and stores the number of guests (step S44). For example, SoC 120 determines the number of guests based on guest member information 302 and stores the same. When there is one set of the user ID and the MAC address data, the number of guests is one, when there are two sets of the user ID and the MAC address data, the number of guests is two, and when there are three sets of the user ID and the MAC address data, the number of guests is three. SoC 120 stores the counted number of guests as the number of guests 304.

SoC 120 then performs processing for transmitting to each guest, time data for synchronization of time data with each guest and the number of guests, together with a game start instruction (step S46). For example, SoC 120 of game apparatus (host) 100-1 transmits the number of guests 304 and time data 306 to game apparatuses (guest) 100-2, 100-3, and 100-4, together with the game start instruction. Game apparatuses (guest) 100-2, 100-3, and 100-4 receive time data 306 and synchronize time. Variation in time can thus be overcome and highly accurate calculation or the like of the amount of delay can be achieved. Game apparatuses (guest) 100-2, 100-3, and 100-4 store the number of guests 304 as the number of guests 334.

The process then ends (return).

When SoC 120 determines in step S36 that the user who is the host has not selected "OK", that is, the user who is the host has selected "reject", in connection check screen 430 (NO in step S36), on the other hand, it stops connection to game apparatus 100 of the guest (for example, P) who desires connection and does not transmit the game start instruction or the like. In this case, the process returns to step S32.

When SoC 120 determines in step S32 that the guest has not been connected (NO in step S32), it determines whether or not an instruction to suspend recruitment has been provided (step S48).

When SoC 120 determines in step S48 that the instruction to suspend recruitment has been provided (YES in step S48), the process proceeds to step S43 and the SoC determines whether or not the operation to start the game has been performed. Determination that the instruction to suspend the member recruitment processing has been provided may be made, for example, when a predetermined period has elapsed since start of the member recruitment processing. Alternatively, determination that the instruction to suspend recruitment has been provided may be made in accordance with an operation instruction from the user.

When SoC 120 determines in step S48 that the instruction to suspend recruitment has not been provided (NO in step S48), on the other hand, the process returns to step S32 and the processing above is repeated.

Though the member recruitment processing in the case of local wireless communication is described above, for example, in the case of the Internet communication, the member recruitment processing using management server 300 may be performed. For example, the host requests management server 300 to generate a matching room, management server 300 generates the matching room and recruits guests, and when matching processing ends, management server 300 may transmit the guest member information to the game apparatus (host) so that the game apparatus (host) transmits necessary data to each game apparatus (guest). For example, the game apparatus (host) may transmit the host information, the number of guests, and time data to each game apparatus (guest), together with the instruction for connection and the game start instruction. Management server 300 may transmit the host information, the number of guests, and time data to the game apparatus (guest G (i)), together with the instruction for connection and the game start instruction. In the case of the Internet communication, the IP address may be used instead of the MAC address included in the guest member information and the host information.

Referring again to FIG. 7, SoC 120 designates the number of guests 304 and calls streaming start processing (step S8). For example, SoC 120 starts streaming processing by calling streaming function program 222 included in game sharing function program 210 in flash memory 106. The streaming processing in accordance with streaming function program 222 will be described later.

SoC 120 then performs operation data obtaining processing (step S10). SoC 120 refers to guest member information 302, receives operation data for each guest transmitted from the corresponding game apparatus (guest) by local wireless communication or the Internet communication, and stores the operation data as operation data 310 in DRAM 108 for each guest (G (i)).

SoC 120 then calculates an antenna level of guest G from loss information of the operation data of guest G and shows the antenna level (step S12). SoC 120 calculates the antenna level of guest G from the operation data (loss information) of the guest that could not be obtained in the operation data obtaining processing in step S10. For example, SoC 120 calculates the antenna level based on the loss information (the number of times of loss by way of example) of the operation data (guest G (i)) per unit time period. When the number of times of loss of the operation data per unit time period is equal to or larger than m, SoC 120 may make determination as level L1. When the loss information of the operation data per unit time period is equal to or more than n (m > n), SoC 120 may make determination as level L2. When the loss information of the operation data per unit time period is less than n, SoC 120 may make determination as level L3. SoC 120 stores the determined level as antenna level data (guest G (i)) 326.

SoC 120 stores the minimum value of the antenna level of each guest G (i) included in antenna level data (guest G (i)) 326 as antenna level data (host) 324. For example, in an example where antenna level data (guest G (1)) 326 is level L3, antenna level data (guest G (2)) 326 is level L2, and antenna level data (guest G (3)) 326 is level L1, antenna level data (host) 324 may be set to level L1. SoC 120 has an icon shown, the icon representing quality of display of the image data transmitted to display 104 of game apparatus (host) 100 in accordance with antenna level data (host) 324. For example, in the case of antenna level data L1, an icon representing one antenna is shown. In the case of antenna level data L2, an icon representing two antennas is shown. In the case of antenna level data L3, an icon representing three antennas is shown.

SoC 120 then performs the game processing based on game program 240, using operation data (host) 308 and operation data (guest G (i)) 310 (step S14).

SoC 120 then performs processing for generating the game image (host) and each game image (guest G (i)) (step S15). SoC 120 stores the generated game image at a side of the host as game image (host) 312. SoC 120 stores the generated game image at a side of each guest (G (i)) as game image (guest G (i)) 314. The game image is stored, with the image ID and the time information issued at the time of generation of the image being associated therewith. Though generation processing in the case of the game processing in the individual image mode is described in the present embodiment, in the game processing in the common image mode, the game image common between the host and the guest may be stored as game image 312.

SoC 120 then determines whether or not another guest has joined late (step S16).

When another guest has joined late in step S16 (YES in step S16), SoC 120 issues a request to change the target bit rate and the VBV buffer size based on the new number of guests in the streaming processing in accordance with streaming function program 222 (step S17). For example, in an example of the game program that accepts late participation of the guest during the game processing, when the guest participates late, guest member information 302 and the number of guests 304 in DRAM 108 of game apparatus (host) 100-1 are updated in accordance with the method described with reference to FIG. 9. In addition, the number of guests 334 in DRAM 108 of game apparatus (guest) 100 is updated.

When SoC 120 determines in step S16 that no other guest has participated late (NO in step S16), on the other hand, step S17 is skipped.

SoC 120 then determines whether or not it has received feedback of image loss from guest G (i) (step S18).

When SoC 120 determines in step S18 that it has received feedback of image loss from guest G (i) (YES in step S18), it stores data on feedback as image loss data of guest G (i) (step S19). For example, when SoC 120 receives information on the image ID of the lost image from guest G (i) as feedback of image loss, it stores the information on the image ID as image loss data 320.

The process then returns to step S10 and the processing above is repeated.

When SoC 120 determines in step S18 that it has not received feedback of image loss from guest G (i) (NO in step S18), on the other hand, step S19 is skipped and the process returns to step S10.

FIG. 11 is a flowchart illustrating mode storing processing in the game sharing function according to the present embodiment. The mode storing processing is performed by reading and execution of host program 220 in flash memory 106.

SoC 120 stores the common image mode or the individual image mode based on designation (designation in S2 in FIG. 7 described above) by the game program (step S50). For example, SoC 120 stores the common image mode or the individual image mode in the game sharing function based on designation data 242 included in game program 240.

SoC 120 then stores local wireless communication or the Internet communication based on selection by the user (notification based on selection in S4 in FIG. 7 described above) (step S52). For example, when the user selects "local wireless communication" icon 412 as described with reference to FIG. 8B, SoC 120 regards the user as having indicated local wireless communication in the game sharing function and stores local wireless communication. When the user selects "the Internet communication" icon 414, on the other hand, the SoC regards the user as having indicated the Internet communication in the game sharing function and stores the Internet communication. The process then ends (end).

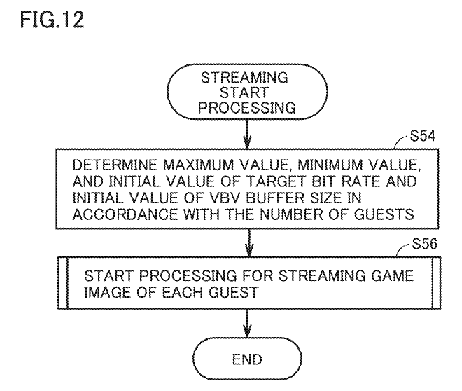

FIG. 12 is a flowchart illustrating streaming start processing according to the present embodiment. Referring to FIG. 12, SoC 120 performs the streaming start processing by executing a streaming start processing program (included in streaming function program 222) in accordance with calling of the streaming start processing described with reference to step S8.

Specifically, SoC 120 determines the maximum value, the minimum value, and an initial value of the target bit rate and an initial value of the VBV buffer size in accordance with the number of guests 304 (step S54). For example, in an example where the number of guests 304 is "3", SoC 120 may set the maximum value of the target bit rate to 3 Mbps, in an example where the number of guests 304 is "2", it may set the maximum value of the target bit rate to 4 Mbps, and in an example where the number of guests 304 is "1", it may set the maximum value of the target bit rate to 5 Mbps. For example, SoC 120 may set all of the minimum values of the target bit rates to the same 0.1 Mbps or may set the minimum value of the target bit rate in accordance with the number of guests 304. For example, SoC 120 may set the maximum value as the initial value of the target bit rate. In an example where the number of guests 304 is "3", SoC 120 may set the initial value of the VBV buffer size to 1.5 M, in an example where the number of guests 304 is "2", it may set the initial value to 2 M, and in an example where the number of guests 304 is "1", it may set the initial value to 2.5 M. Though an example where the maximum value, the minimum value, and the initial value of the target bit rate and the initial value of the VBV buffer size are determined in accordance with the number of guests is described by way of example, the number of guests may be set to the upper limit value of the number of guests supported by the game program. The game apparatus (guest) that participates late during the game processing can statically be addressed.

Since the initial value of the VBV buffer size is set in accordance with the number of guests or the upper limit value thereof in the present embodiment, the VBV buffer size can appropriately be set.

SoC 120 stores the data determined for each guest G (i) as image target bit rate (guest G (i)) 316 and image VBV buffer size (guest G (i)) 319. The initial value is set to the current value.

SoC 120 then starts processing for streaming the game image of each guest G (i) in accordance with the determination (step S56). Details of the streaming processing will be described later. The process then ends (end).

Though processing in step S54 for changing the maximum value or the like of the target bit rate in accordance with the number of guests 304 is described, in the case of the Internet communication in which there is a margin in a communication channel, the processing may or may not be performed.

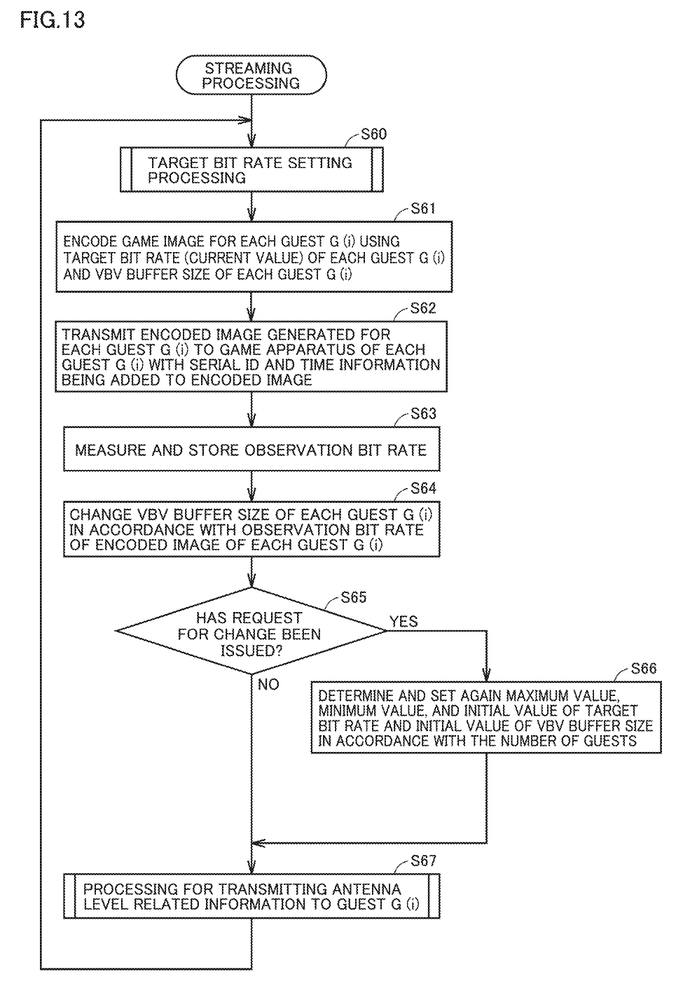

FIG. 13 is a sub routine flowchart of the streaming processing according to the present embodiment. The streaming processing is performed by execution of the streaming function program by SoC 120. Referring to FIG. 13, SoC 120 performs target bit rate setting processing (step S60). The target bit rate setting processing is performed in correspondence with each guest G (i).

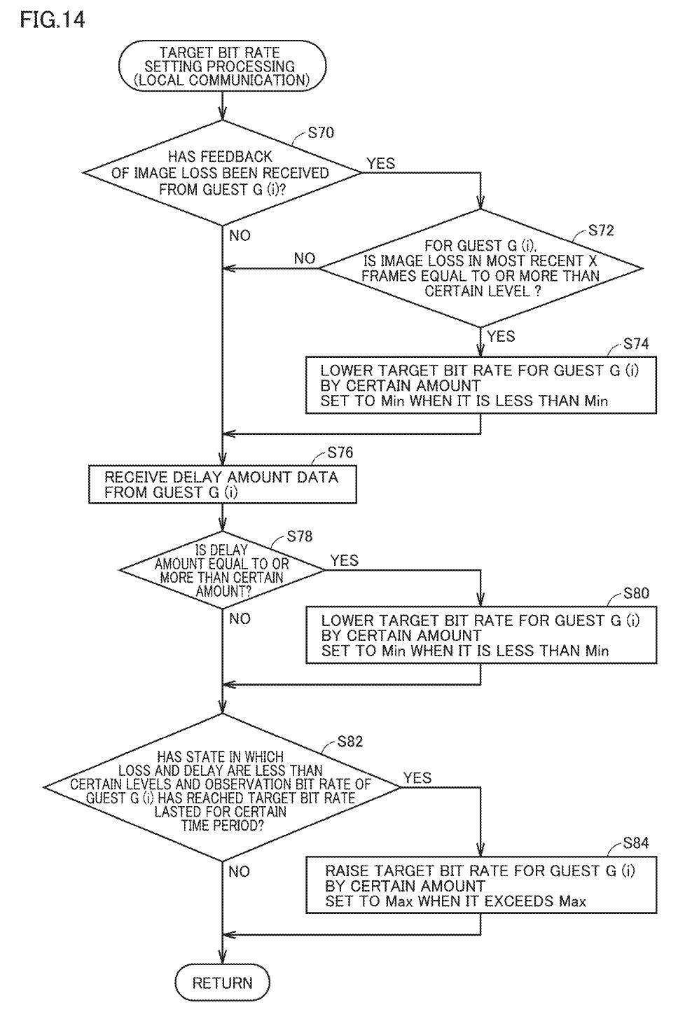

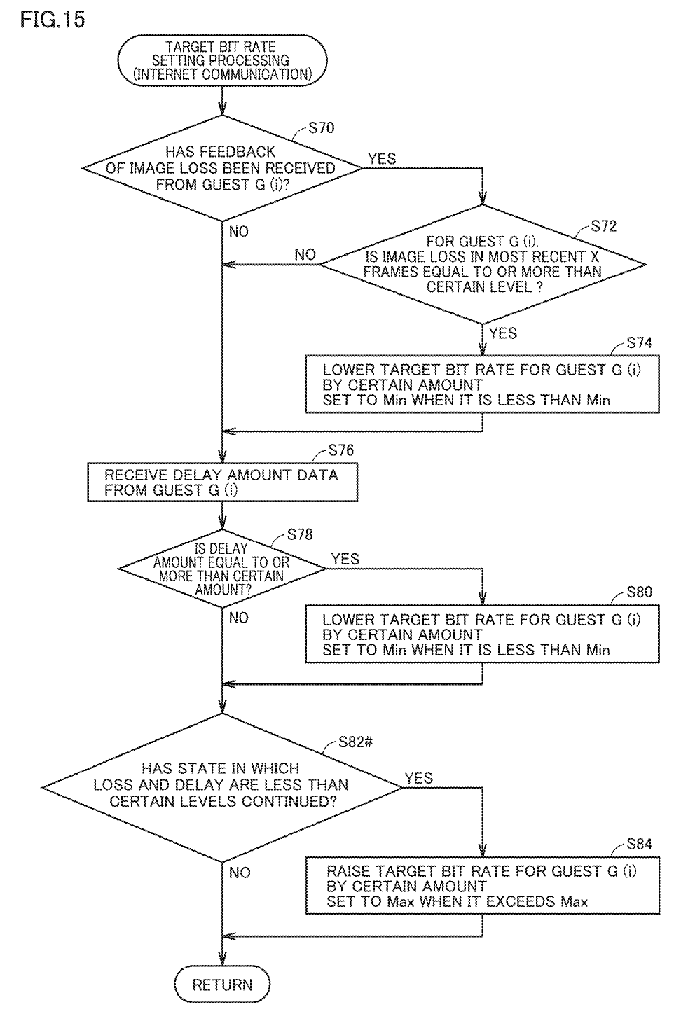

FIG. 14 is a sub routine flowchart of the target bit rate setting processing according to the present embodiment. The case of local wireless communication will be described with reference to FIG. 14. SoC 120 determines whether or not it has received feedback of image loss from guest G (i) (step S70). For example, SoC 120 determines whether or not image loss corresponding to guest G (i) has been stored by referring to image loss data 320. When SoC 120 determines in step S70 that it has received feedback of image loss (YES in step S70), it determines whether or not image loss is equal to or more than a certain level in most recent X frame(s) for guest G (i) (step S72). X may be set to any value equal to or larger than one. For example, game apparatus (host) 100 at the side of the host transmits the game image in one frame as being divided into a plurality of communication packets. Game apparatus (guest) 100 at the side of the guest determines whether or not it has received all transmitted communication packets, and when even one of the plurality of communication packets is lost, it gives feedback of image loss in that frame (image ID).

When SoC 120 determines in step S72 that image loss in most recent X frame(s) is equal to or more than the certain level for guest G (i) (YES in step S72), it lowers the target bit rate by a certain amount for guest G (i) (step S74). When the target bit rate becomes less than a lower limit value Min, SoC 120 sets the target bit rate to lower limit value Min. The process then proceeds to step S76.

When SoC 120 determines in step S72 that image loss in most recent X frame(s) is less than the certain level for guest G (i) (NO in step S72) or when it determines that it has not received feedback of image loss from guest G (i) (NO in step S70), on the other hand, the process proceeds to step S76.

In step S76, SoC 120 receives delay amount data from guest G (i) (step S76). For example, SoC 120 receives the delay amount data transmitted from game apparatus 100 of guest G (i) and stores the delay amount data in DRAM 108 as delay amount data 322.

SoC 120 then determines whether or not the amount of delay is equal to or more than a certain level based on delay amount data 322 of guest G (i) stored in DRAM 108 (step S78). When SoC 120 determines in step S78 that the amount of delay is equal to or more than the certain level for guest G (i) (YES in step S78), it lowers the target bit rate by a certain amount for guest G (i) (step S80). When the target bit rate becomes less than lower limit value Min, SoC 120 sets the target bit rate to lower limit value Min. The process then proceeds to step S82. SoC 120 may determine that an amount of increase in delay is equal to or more than a certain level, without being limited to determination as to whether or not the amount of delay is equal to or more than the certain level based on delay amount data 322 of guest G (i) stored in DRAM 108.

When SoC 120 determines in step S78 that the amount of delay is not equal to or more than the certain level for guest G (i) (NO in step S78), on the other hand, the process proceeds to step S82.

SoC 120 then determines whether or not a state in which image loss and the amount of delay are less than certain levels for guest G (i) and the observation bit rate of guest G (i) has reached the target bit rate has lasted for a certain time period (step S82).

When SoC 120 determines in step S82 that the state in which image loss and the amount of delay are less than certain levels for guest G (i) and the observation bit rate of guest G (i) has reached the target bit rate has lasted for the certain time period (YES in step S82), it raises the target bit rate by a certain amount for guest G (i) (step S84). When the target bit rate exceeds an upper limit value Max, SoC 120 sets the target bit rate to upper limit value Max. The process then ends (return).

When SoC 120 determines in step S82 that the state in which image loss and the amount of delay are less than certain levels for guest G (i) and the observation bit rate of guest G (i) has reached the target bit rate has not lasted for the certain time period (NO in step S82), step S84 is skipped and the process ends (return).

The state in which image loss and the amount of delay are less than the certain levels refers to a state in which a communication status is stable. The state in which the observation bit rate has reached the target bit rate having lasted for the certain time period refers to a state in which an amount of information on the current game image is transmitted at an appropriate target bit rate having lasted for the certain time period. When these states are established, the target bit rate is raised by the certain amount.

FIG. 15 is another sub routine flowchart of the target bit rate setting processing according to the present embodiment. The case of the Internet communication will be described with reference to FIG. 15. FIG. 15 is different from the flowchart in FIG. 14 in replacement of step S82 with step S82#. Since the process is otherwise similar to that described with reference to FIG. 14, detailed description thereof will not be repeated.

In step S82#, SoC 120 determines whether or not a state in which image loss and the amount of delay are less than certain levels has lasted for a certain time period (step S82#).

When SoC 120 determines in step S82# that the state in which image loss and the amount of delay are less than the certain levels has lasted for the certain time period for guest G (i) (YES in step S82#), it raises the target bit rate by the certain amount for guest G (i) (step S84). When the target bit rate exceeds upper limit value Max, SoC 120 sets the target bit rate to upper limit value Max. The process then ends (return).

When SoC 120 determines in step S82# that the state in which image loss and the amount of delay are less than the certain levels has not lasted for the certain time period for guest G (i) (NO in step S82#), step S84 is skipped and the process ends (return).

The state in which image loss and the amount of delay are less than the certain levels refers to the state in which the communication status is stable. In the case of the Internet communication, in that state, the target bit rate is raised by the certain amount. In change from a simple game image to a complicated game image, in the case of the Internet communication, even when the target bit rate and the observation bit rate abruptly deviate from each other and load in the communication channel greatly fluctuates, there is a margin in the communication channel and hence increase in image loss and amount of delay are less likely. In the case of local wireless communication, on the other hand, the communication channel is restricted, and hence abrupt fluctuation in load in the communication channel may cause increase in image loss and amount of delay. Therefore, in the case of local wireless communication, abrupt deviation between the target bit rate and the observation bit rate is suppressed by setting as a condition, whether or not the state in which the amount of information on the current game image is transmitted at an appropriate target bit rate has lasted for the certain time period. The condition may be added also to the case of the Internet communication.

In the present example, the target bit rate for encoding is thus set in accordance with the number of guests or the upper limit value thereof. A limited communication band can thus efficiently be used to transmit the game image generated by the host to the guest.

By setting the target bit rate based on the upper limit value of the guest, late participation of the guest can also effortlessly be addressed.

Since the initial value of the target bit rate is set in accordance with the number of guests or the upper limit value thereof and thereafter the target bit rate is varied in accordance with each factor, adaptation to a state after start of play can be made. In this case again, a maximum target bit rate is determined in accordance with the number of guests or the upper limit value thereof, and the bit rate equal to or higher than that is not set. Therefore, the target bit rate can be set within a range in accordance with the number of guests or the upper limit value thereof.

Referring again to FIG. 13, SoC 120 then encodes the image for each guest G (i) using the target bit rate (current value) of each guest G (i) and the VBV buffer size of each guest G (i) (step S61). SoC 120 encodes the image for each guest G (i) in a manner varied in bit rate. Encoding may be performed in a manner varied in target bit rate for encoding in accordance with the communication state. Encoding may be performed in such a manner that the observation bit rate resulting from encoding in accordance with the amount of information on the image for each guest G (i) is varied. Encoding may be performed in a manner increased in set bit rate for encoding, based on comparison between the target bit rate for encoding and the observation bit rate resulting from encoding. For example, SoC 120 performs encoding processing of image data stored in frame buffer 110 in accordance with the target bit rate and the VBV buffer size. SoC 120 selects an appropriate encoding mode by optimization processing in accordance with the target bit rate and a remainder of the VBV buffer size and performs the encoding processing in accordance with the selected encoding mode.

SoC 120 then transmits the encoded image generated for each guest G (i) to game apparatus 100 of each guest G (i), with the image ID and the time information being added thereto (step S62).

SoC 120 then measures and stores the observation bit rate (step S63). SoC 120 measures and stores as the observation bit rate, the bit rate (resultant bit rate) of transmission data resulting from encoding. For example, SoC 120 can measure an amount of transmission data outputted along a time axis and can calculate the observation bit rate by dividing the amount by a measurement time period. SoC 120 stores the calculated measurement bit rate as image observation bit rate (guest G (i)) 318.

SoC 120 then changes the VBV buffer size of each guest G (i) in accordance with the observation bit rate of the encoded image of each guest (step S64).

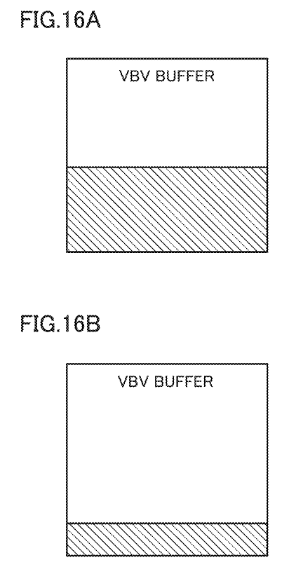

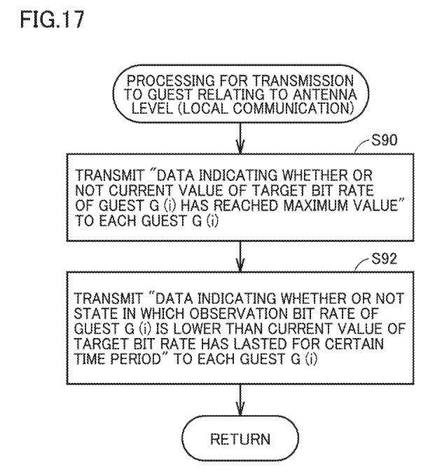

FIGS. 16A and 16B are each a diagram illustrating change of the VBV buffer size according to the present embodiment. FIG. 16A shows the initial value of the VBV buffer size by way of example. SoC 120 sets the initial value of the VBV buffer size based on the number of guests 304. SoC 120 changes for each game apparatus (guest G (i)), the value of the VBV buffer size for each game apparatus (guest G (i)), based on the bit rate (observation bit rate) resulting from encoding of the game image of the game apparatus (guest G (i)). As shown, for example, in FIG. 16B, for example, the value of the VBV buffer size may be set to 1/2 of the observation bit rate for each game apparatus (guest G (i)). SoC 120 stores the resultant value of the VBV buffer size as VBV buffer size (guest G (i)) 319.

Referring again to FIG. 13, SoC 120 then determines whether or not a request for change has been issued (step S65). SoC 120 determines whether or not the request for change has been issued as processing in step S17 in FIG. 7.

When SoC 120 determines in step S65 that the request for change has been issued (YES in step S65), it determines and sets again the maximum value, the minimum value, and the initial value of the target bit rate and the initial value of the VBV buffer size in accordance with the number of guests (step S66). The process then proceeds to step S67.

When SoC 120 determines in step S65 that the request for change has not been issued (NO in step S65), on the other hand, step S66 is skipped and the process proceeds to step S67.

In step S67, SoC 120 performs processing for transmitting antenna level related information to guest G (i) (step S67). Details of the processing for transmitting the antenna level related information to guest G (i) will be described later.

The process then returns to step S60 and the processing above is repeated.

FIG. 17 is a sub routine flowchart of the processing for transmitting the antenna level related information to guest G (i) according to the present embodiment. The case of local wireless communication will be described with reference to FIG. 17. SoC 120 transmits to guest G (i), "data indicating whether or not the current value of the target bit rate of guest G (i) has reached the maximum value" (step S90). For example, the "data indicating whether or not the current value of the target bit rate of guest G (i) has reached the maximum value" is "0" or "1" flag information.

SoC 120 then transmits to guest G (i), "data indicating whether or not a state in which the observation bit rate of guest G (i) is lower than the current value of the target bit rate has lasted for a certain time period" (step S92). For example, the "data indicating whether or not a state in which the observation bit rate of guest G (i) is lower than the current value of the target bit rate has lasted for a certain time period" is "0" or "1" flag information.

The process then ends (return).

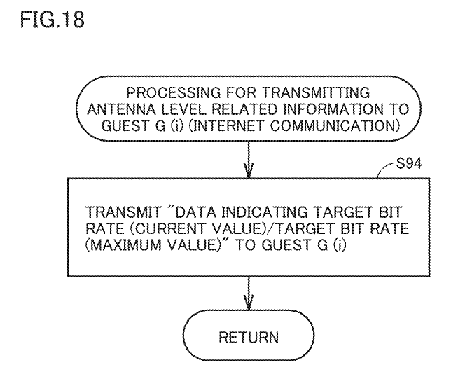

FIG. 18 is another sub routine flowchart of the processing for transmitting the antenna level related information to guest G (i) according to the present embodiment. The case of the Internet communication will be described with reference to FIG. 18. SoC 120 calculates for each guest G (i), "the target bit rate (current value)/the target bit rate (maximum value) of guest G (i)" and transmits data indicating a value of a result of calculation to guest G (i) (step S94).

The process then ends (return).

The processing for transmitting the antenna level related information to guest G (i) may be performed every predetermined period. For example, the processing may be performed, for example, once in several seconds.

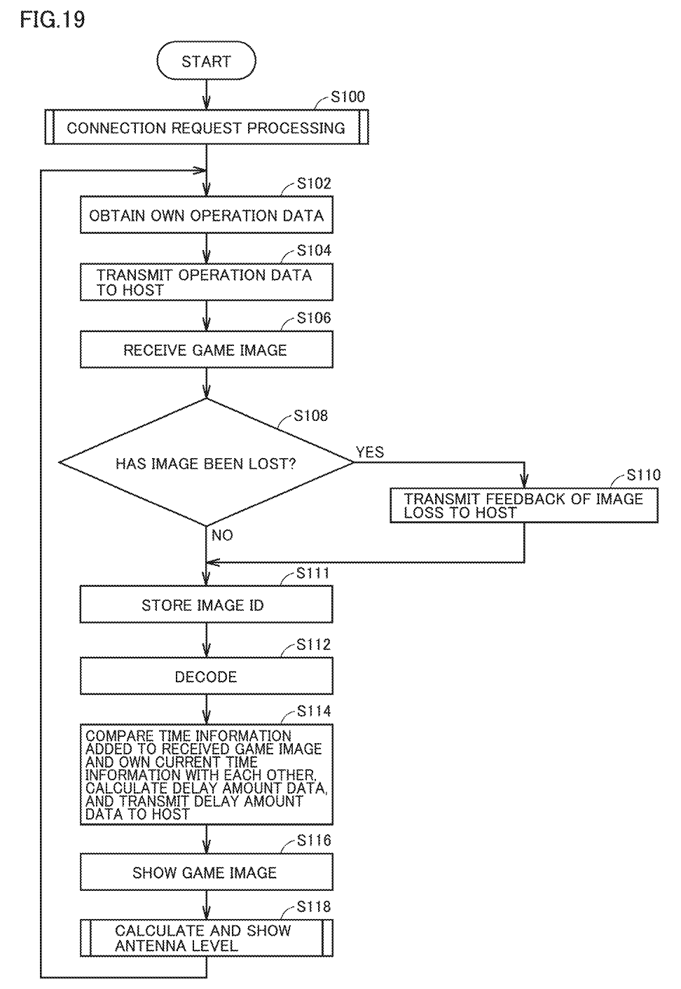

FIG. 19 is a flowchart illustrating the game processing in the game apparatus (guest) according to the present embodiment. A processing procedure shown in FIG. 19 is realized by execution by SoC 120 of each game apparatus (guest) 100, of guest program 230 included in system program 200 stored in flash memory 106.

SoC 120 of the game apparatus (guest) performs connection request processing (step S100). Details of the connection request processing will be described later.

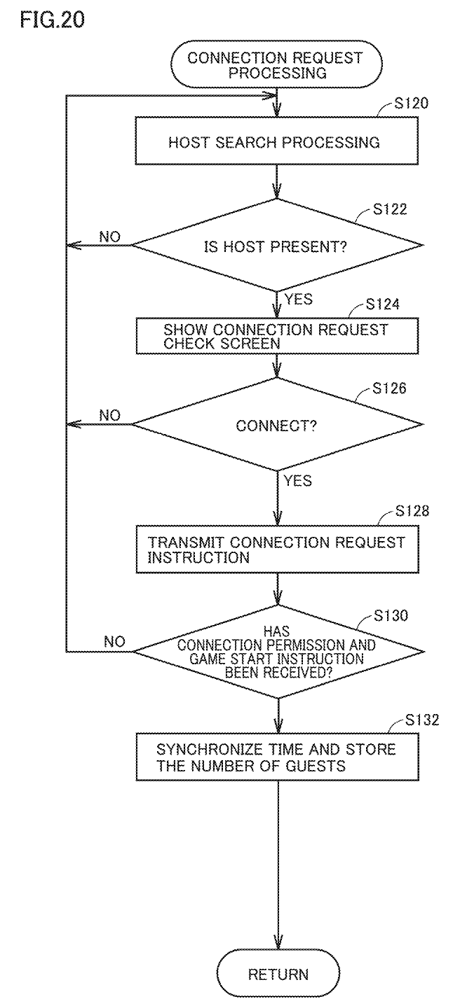

FIG. 20 is a sub routine flowchart of the connection request processing in the game apparatus (guest) according to the present embodiment.

Though there are various methods for the connection request processing, the case of local wireless communication will be described with reference to FIG. 20 by way of example. SoC 120 of game apparatus (guest G (i)) 100 performs host search processing for searching for game apparatus (host) 100 to be the host (the host that transmits advertisement for recruitment) by local wireless communication (step S120).

SoC 120 of game apparatus (guest G (i)) 100 then determines whether or not the host is present (step S122). When the host is not present in step S122 (NO in step S122), the process returns to step S120 and SoC 120 of game apparatus (guest G (i)) 100 continues the host search processing.

When SoC 120 determines in step S122 that the host is present (YES in step S122), on the other hand, it has a connection request check screen shown on display 104, for selection as to whether or not to meet the request for connection (step S124).

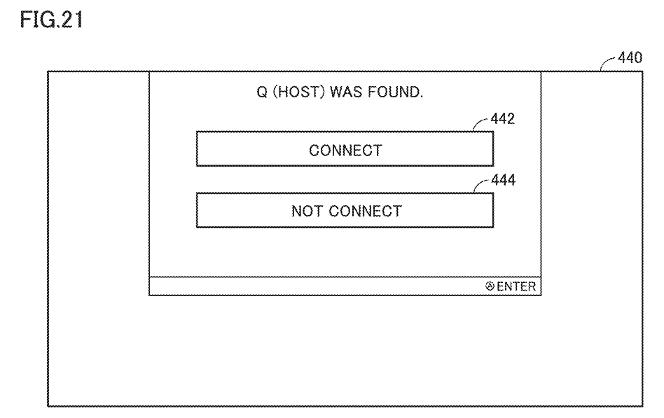

FIG. 21 is a diagram illustrating an exemplary connection request check screen according to the present embodiment. Referring to FIG. 21, a connection request check screen 440 is provided, for example, with a "connect" button 442 for requesting connection and a "not connect" button 444 for not requesting connection, together with comments "Q (host) was found." For example, when the user who is the guest selects "connect" button 442 in connection request check screen 440, an instruction for request for connection is transmitted from the guest game apparatus (guest) to host game apparatus (host) 100. When the user who is the guest selects "not connect" button 444 in connection request check screen 440, on the other hand, the instruction for request for connection is not transmitted from the guest game apparatus (guest) to host game apparatus (host) 100.

Referring again to FIG. 20, SoC 120 of game apparatus (guest G (i)) 100 determines whether or not the user who is the guest has selected "connect" in connection request check screen 440 (step S126).

When SoC 120 of game apparatus (guest G (i)) 100 determines in step S126 that the user who is the guest has selected "not connect" in connection request check screen 440 (NO in step S126), the process returns to step S120.

When SoC 120 of game apparatus (guest G (i)) 100 determines in step S126 that the user who is the guest has selected "connect" in connection request check screen 440 (YES in step S126), on the other hand, it transmits the instruction for request for connection from the guest game apparatus (guest) to host game apparatus (host) 100 (step S128).

SoC 120 of game apparatus (guest G (i)) 100 then determines whether or not it has received connection permission and the game start instruction from host game apparatus (host) 100 (step S130).

When SoC 120 of game apparatus (guest G (i)) 100 determines in step S130 that it has received connection permission and the game start instruction from host game apparatus (host) 100 (YES in step S130), it performs processing for synchronization of time and receives the number of guests from the host and stores the same (step S132). For example, SoC 120 of game apparatus (guest G (i)) 100 receives time data 306 and the number of guests 304 from game apparatus (host) 100-1. Game apparatus (guest G (i)) 100 receives time data 306 and synchronizes time. SoC 120 of game apparatus (guest G (i)) 100 stores the received number of guests 304 as the number of guests 334 in DRAM 108.

The process then ends (return).

The connection request processing in the case of local wireless communication is described above. For example, in the case of the Internet communication, the host search processing for searching for game apparatus (host) 100 may be performed by accessing the matching room generated by management server 300. Then, for the host found in the matching room, the connection request check screen described with reference to FIG. 21 may be shown on display 104 and whether or not to meet the request for connection may be selected. When the user who is the guest issues the request for connection, the instruction for request for connection may be transmitted from guest game apparatus (guest) 100 via management server 300 to host game apparatus (host) 100, and host game apparatus (host) 100 may transmit the host information, the number of guests, and time data to guest game apparatus (guest) 100, together with connection permission and the game start instruction.

Referring again to FIG. 19, SoC 120 of game apparatus (guest G (i)) 100 then obtains the operation data thereof (step S102). SoC 120 of game apparatus (guest G (i)) 100 obtains operation data (guest) 338 stored in DRAM 108.

SoC 120 of game apparatus (guest G (i)) 100 then transmits operation data (guest) 338 to the host (step S104).

SoC 120 of game apparatus (guest G (i)) 100 then receives the game image (step S106). For example, SoC 120 of game apparatus (guest G (i)) 100 receives transmitted game image (guest G (i)) 314 and stores the game image as game image 340.

SoC 120 of game apparatus (guest G (i)) 100 then determines whether or not the image has been lost (step S108). SoC 120 of game apparatus (guest G (i)) 100 determines whether or not the image has been lost by referring to image ID 341 of the most recent image and comparing the image ID with the image ID associated with the game image received from the host. For example, in an example where the image ID is the serial ID, when the serial IDs sequentially arrive, determination that no image has been lost is made. When the image IDs are not consecutive but there is a missing image ID, on the other hand, determination that the image corresponding to the missing image ID has been lost is made.

When SoC 120 of game apparatus (guest G (i)) 100 determines in step S108 that the image has been lost (YES in step S108), it transmits feedback of image loss to the host (step S110). For example, SoC 120 of game apparatus (guest G (i)) 100 transmits feedback including information on the serial IDs before and after loss or a number of missing serial ID to game apparatus (host) 100.

SoC 120 of game apparatus (guest G (i)) 100 then stores the serial ID associated with the received game image as serial ID 341 of the most recent image.

When SoC 120 of game apparatus (guest G (i)) 100 determines in step S108 that no image has been lost (NO in step S108), on the other hand, step S110 is skipped and the process proceeds to step S111.

SoC 120 of game apparatus (guest G (i)) 100 then performs decoding processing (step S112). For example, transmitted game image (guest G (i)) 314 subjected to the encoding processing includes information on the encoding mode used for the encoding processing. SoC 120 of game apparatus (guest G (i)) 100 performs decoding processing on the image data subjected to the encoding processing based on the information on the encoding mode and develops the resultant image data in frame buffer 110.

SoC 120 of game apparatus (guest G (i)) 100 then compares the time information added to the received game image and the current time information thereof with each other, calculates the delay amount data, and transmits the delay amount data to the host (step S114). For example, SoC 120 of game apparatus (guest G (i)) 100 compares the time information added to the received game image and time data 336 with each other, calculates delay amount data 343 relating to the amount of delay, and transmits calculated delay amount data 343 to game apparatus (host) 100.

SoC 120 of game apparatus (guest G (i)) 100 then shows the game image resulting from the decoding processing (step S116). For example, SoC 120 has the game image developed in frame buffer 110 shown on display 104.

SoC 120 of game apparatus (guest G (i)) 100 then performs antenna level calculation and display processing (step S118). The antenna level calculation and display processing is realized by execution of guest program 230 by SoC 120. Details of the antenna level calculation and display processing will be described later. The process then returns to step S102 and the processing is continued.

For example, the antenna level may be calculated based on both of the communication state (the image loss data and the delay amount data) in communication of the game image and the bit rate (the target bit rate and the observation bit rate) for encoding or at least one of them. The antenna level may be calculated based on the communication state (the image loss data) and the target bit rate or the observation bit rate. The antenna level may be calculated based on a result of comparison based on comparison between the target bit rate and the observation bit rate. In determination of the communication state, both or one of the delay amount data of the game image and the image loss data on the communication channel may be determined. In an example where local wireless communication has been selected, the communication state may be determined at least based on the image loss data on the communication channel, and in an example where the Internet communication has been selected, the communication state may be determined at least based on the delay amount data. In the example where local wireless communication has been selected, the communication state may be determined based on the target bit rate and the image loss data on the communication channel, and in the example where the Internet communication has been selected, the communication state may be determined based on the target bit rate and the delay amount data.

The antenna level may be expressed with one icon that changes depending on both of the communication state in communication of the game image and the bit rate for encoding.

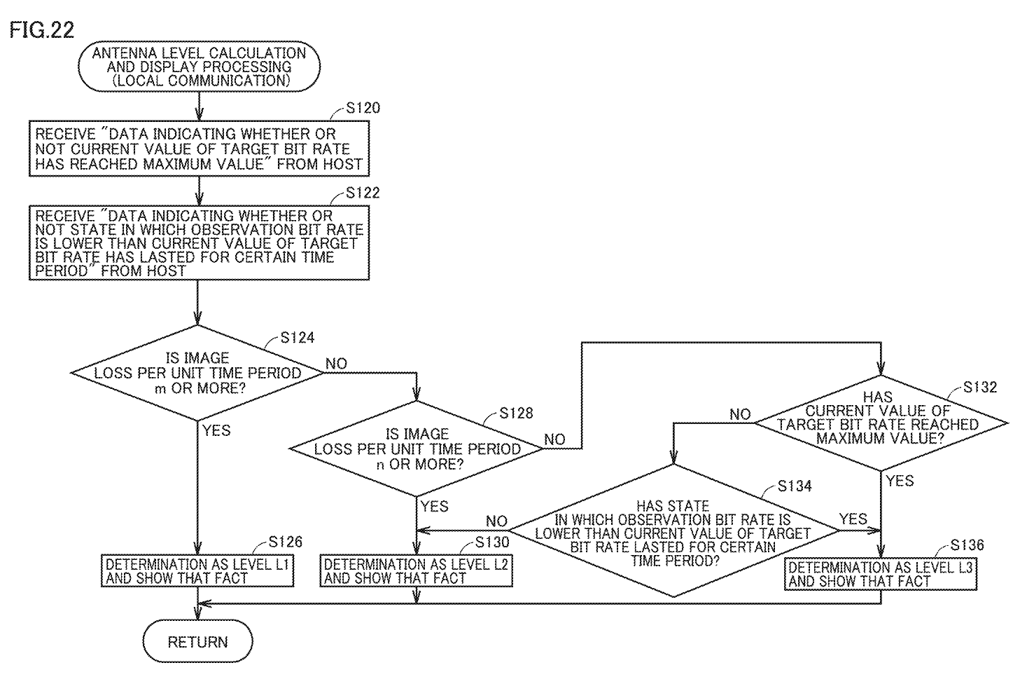

FIG. 22 is a sub routine flowchart of the antenna level calculation and display processing according to the present embodiment. The case of local wireless communication will be described with reference to FIG. 22. SoC 120 of game apparatus (guest G (i)) 100 receives "data indicating whether or not the current value of the target bit rate of guest G (i) has reached the maximum value" from the host (step S120).

SoC 120 of game apparatus (guest G (i)) 100 then receives "data indicating whether or not a state in which the observation bit rate of guest G (i) is lower than the current value of the target bit rate has lasted for a certain time period" from the host (step S122).

SoC 120 of game apparatus (guest G (i)) 100 then determines whether or not image loss per unit time period is equal to or more than m (step S124). For example, SoC 120of game apparatus (guest G (i)) 100 may determine whether or not image loss is equal to or more than m by counting the number of missing serial IDs associated with the game image most recently received from the host per unit time period by referring to image loss data 342. Alternatively, SoC 120 of game apparatus (guest G (i)) 100 may determine whether or not image loss is equal to or more than m based on the number of times of transmission of feedback per unit time period.

When SoC 120 of game apparatus (guest G (i)) 100 determines in step S124 that image loss per unit time period is equal to or more than m (YES in step S124), it makes determination as level L1, has the level stored as antenna level data 344, and has the antenna corresponding to level L1 shown (step S126). The process then ends (return).

When SoC 120 of game apparatus (guest G (i)) 100 determines in step S124 that image loss per unit time period is less than m (NO in step S124), on the other hand, it determines whether or not image loss per unit time period is equal to or more than n (step S128).

When SoC 120 of game apparatus (guest G (i)) 100 determines in step S128 that image loss per unit time period is equal to or more than n (YES in step S128), on the other hand, it makes determination as level L2, has the level stored as antenna level data 344, and has the antenna corresponding to level L2 shown (step S130). The process then ends (return).

When SoC 120 of game apparatus (guest G (i)) 100 determines in step S128 that image loss per unit time period is less than n (NO in step S128), on the other hand, it determines whether or not the current value of the target bit rate has reached the maximum value (step S132).

When SoC 120 of game apparatus (guest G (i)) 100 determines in step S132 that the current value of the target bit rate has reached the maximum value (YES in step S132), it makes determination as level L3, has the level stored as antenna level data 344, and has the antenna corresponding to level L3 shown (step S136). For example, when the flag received in step S120 is "1", SoC 120 of game apparatus (guest G (i)) 100 may make determination as level L3. The process then ends (return).

When SoC 120 of game apparatus (guest G (i)) 100 determines in step S132 that the current value of the target bit rate has not reached the maximum value (NO in step S132), on the other hand, it determines whether or not the state in which the observation bit rate is lower than the current value of the target bit rate has lasted for a certain time period (step S134). For example, when the flag received in step S120 is "1", SoC 120 of game apparatus (guest G (i)) 100 determines whether or not the flag received in step S122 is "1".

When SoC 120 of game apparatus (guest G (i)) 100 determines in step S134 that the state in which the observation bit rate is lower than the current value of the target bit rate has lasted for the certain time period (YES in step S134), it has the antenna at level L3 shown (step S136). The process then ends (return). For example, when the flag received in step S122 is "1", SoC 120 of game apparatus (guest G (i)) 100 makes determination as level L3. In the case of the simple game image, the target bit rate may not reach the maximum value. Therefore, while the state in which the observation bit rate is lower than the current value of the target bit rate lasts for the certain time period and image quality is stable, determination as level L3 is made.

When SoC 120 of game apparatus (guest G (i)) 100 determines in step S134 that the state in which the observation bit rate is lower than the current value of the target bit rate has not lasted for the certain time period (NO in step S134), on the other hand, it has the antenna at level L2 shown (step S130). The process then ends (return). For example, when the flag received in step S122 is "0", SoC 120 of game apparatus (guest G (i)) 100 may make determination as level L2.

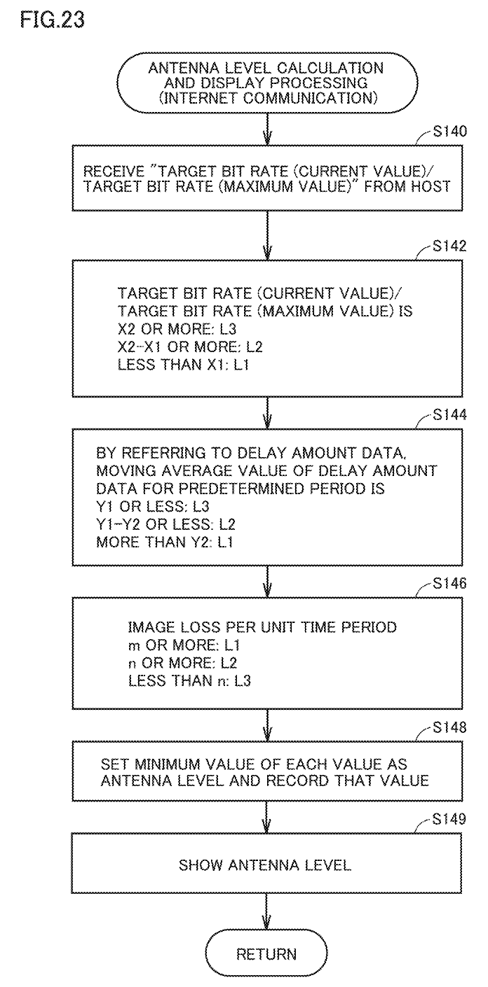

FIG. 23 is another sub routine flowchart of the antenna level calculation and display processing according to the present embodiment. The case of the Internet communication will be described with reference to FIG. 23. SoC 120 (guest) receives "data indicating whether or not the target bit rate (current value)/the target bit rate (maximum value) of guest G has been reached" from the host (step S140).

SoC 120 of game apparatus (guest G (i)) 100 then determines whether or not the target bit rate (current value)/the target bit rate (maximum value) of guest G is equal to or more than X2, and when the result is equal to or more than X2, it makes determination as level L3. When the target bit rate (current value)/the target bit rate (maximum value) of guest G is smaller than X2 and equal to or more than X1, SoC 120 of game apparatus (guest G (i)) 100 makes determination as level L2. When the target bit rate (current value)/the target bit rate (maximum value) of guest G is smaller than X1, SoC 120 of game apparatus (guest G (i)) 100 makes determination as level L1 (step S142).

SoC 120 of game apparatus (guest G (i)) 100 then determines whether or not an average value of the delay amount data for a predetermined period is equal to or less than Y1 by referring to the delay amount data. When the average value is equal to or less than Y1, the SoC makes determination as level L3. When the average value of the delay amount data for the predetermined period is larger than Y1 and equal to or less than Y2, SoC 120 of game apparatus (guest G (i)) 100 makes determination as level L2. When the average value of the delay amount data for the predetermined period is larger than Y2, SoC 120 of game apparatus (guest G (i)) 100 makes determination as level L1 (step S144).

SoC 120 of game apparatus (guest G (i)) 100 then determines whether or not image loss per unit time period is equal to or more than m. When image loss is equal to or more than m, the SoC makes determination as level L1, When image loss is equal to or more than n, the SoC makes determination as level L2. When image loss is less than n, the SoC makes determination as level L3 (step S146). As set forth above, for example, SoC 120 of game apparatus (guest G (i)) 100 may determine whether or not image loss is equal to or more than m or n by counting the number of missing serial IDs associated with the game image most recently received from the host per unit time period by referring to image loss data 342. Alternatively, SoC 120 of game apparatus (guest G (i)) 100 may determine whether or not image loss is equal to or more than m or n based on the number of times of transmission of feedback per unit time period.

SoC 120 of game apparatus (guest G (i)) 100 then sets the average value of values as the antenna level and records the same (step S148). The minimum value of the values may be set as the antenna level. For example, SoC 120 of game apparatus (guest G (i)) 100 stores the determined data as antenna level data 344 in DRAM 108.

SoC 120 of game apparatus (guest G (i)) 100 then has the antenna level shown based on antenna level data 344 (step S149). The process then ends (return).

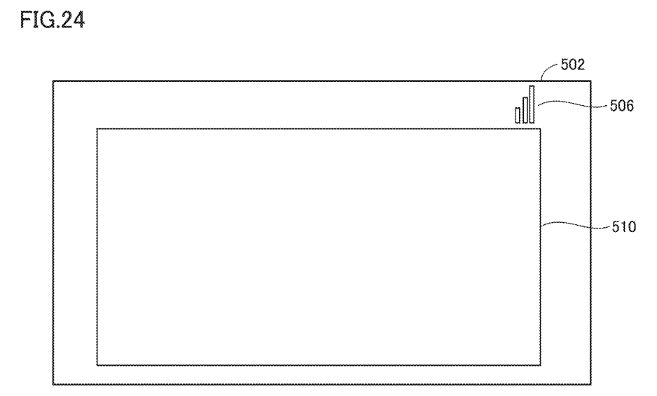

FIG. 24 is a diagram illustrating a screen of display 104 of the game apparatus according to the present embodiment. FIG. 24 shows a screen 502 on display 104. In screen 502, a game image 510 is shown and an antenna 506 representing display quality is shown. SoC 120 of game apparatus (host) 100 has antenna 506 shown based on antenna level data 324. SoC 120 of game apparatus (guest G (i)) 100 has antenna 506 shown based on antenna level data 344. In the present embodiment, an icon of three standing antennas corresponding to level L3 is shown. For example, in the case of level L2, an icon of two standing antennas may be shown, and in the case of level L1, an icon of one standing antenna may be shown. Information indicating display quality may be shown in another manner such as a numerical value or characters, without being limited to the number of antennas. The host user can thus readily know quality of display of the transmitted image by checking antenna 506 of game apparatus (host) 100. Antenna level data 324 is antenna level data lowest in level among antenna level data 326 of game apparatuses (guest G (i)) 100. Therefore, appropriate measures such as an attempt to improve the communication status can be taken by the host in accordance with the level of display quality. The guest user can readily know quality of display of the received image by checking antenna 506 of game apparatus (guest) 100. Therefore, appropriate measures such as an attempt to improve the communication status can be taken by the guest in accordance with the level of display quality.

In a game using the game sharing function in which the host apparatus generates the game image and transmits the game image to the guest apparatus, conveyance of current display quality of the game image at the guest apparatus may be an issue. In the present embodiment, display quality is shown in real time with one icon together with the game image, and hence the display quality of the game image during play can be known in real time.

### F. Modification

An example in which each game apparatus (guest G (i)) 100 determines the antenna level and shows a result of determination in the antenna level calculation and display processing according to the embodiment is described. Game apparatus (host) 100, on the other hand, may determine the antenna level of each game apparatus (guest G (i)) 100. For example, in local wireless communication, SoC 120 of game apparatus (host) 100 holds the "data indicating whether or not the current value of the target bit rate of guest G (i) has reached the maximum value" and the "data indicating whether or not the state in which the observation bit rate of guest G (i) is lower than the current value of the target bit rate has lasted for the certain time period" without transmitting them to game apparatus (guest G (i)) 100 but may make determination by using image loss data 320 to perform the processing described with reference to FIG. 22. SoC 120 of game apparatus (host) 100 may transmit the result of determination to game apparatus (guest G (i)) 100 and have antenna 506 shown based on antenna level data 3344 in accordance with the received result of determination. This is similarly applicable also to the Internet communication, without being limited to application to local wireless communication. In the case of the Internet communication, instead of the processing in step S12 in FIG. 7, SoC 120 of game apparatus (host) 100 may hold the result of calculation of the antenna level in accordance with the method described with reference to FIG. 23 as antenna level data (host) 324 and may show the result of calculation on display 104.

The target bit rate setting processing (FIG. 14) and the antenna level calculation and display processing (FIG. 22) in local wireless communication may be used in the Internet communication. The target bit rate setting processing (FIG. 15) and the antenna level calculation and display processing (FIG. 23) in the Internet communication may be used in local wireless communication.

Though the game system that mainly performs the game processing is described in the embodiment above, limitation to the game processing is not intended. The game system is similarly applicable, for example, also to an information processing system that distributes video. For example, a first information processing apparatus encodes video and transmits the encoded video. A second information processing apparatus receives and shows the video transmitted from the first information processing apparatus, determines display quality of the video therein based on the communication state in communication of the video and the bit rate for encoding, and shows one icon representing the display quality on a display thereof, together with the video.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A game system comprising:
a first game apparatus comprising
one or more processors and/or processing circuits, and
one or more memories storing instructions that cause the one or more processors to perform first operations comprising
receiving input data of asecond game apparatus,
executing a game program using input data of the first game apparatus and the received input data,
generating a game image,
setting, based on the number of second game apparatuses, a bit rate for encoding the generated game image,
encoding of the generated game image based on the set bit rate, and
transmitting the encoded game image to the second game apparatus; and
the second game apparatus comprising
one or more processors, and
one or more memories storing instructions that cause the one or more processors to perform second operations comprising
receiving the transmitted game image,
decoding the received game image, and
displaying the decoded game image on a display of the second game apparatus.

2. The game system according to claim 1, wherein
the first operations further comprise determining the number of the second game apparatuses at a start of a game, and
the setting is performed based on the determined number of the second game apparatuses.

3. The game system according to claim 1, wherein
the setting comprises setting an initial value of the bit rate based on the number of the second game apparatuses, and
in the encoding, the bit rate is varied according to a communication state of the game image.

4. The game system according to claim 3, wherein
the encoding further comprises varying the bit rate of a result of the encoding according to an amount of information of the game image.

5. The game system according to claim 3, wherein
the initial value is set in common for a plurality of second game apparatuses,
in the encoding, the bit rate is varied for each of the second game apparatuses according to the communication state for each of the second game apparatuses, and
the encoding comprises the encoding of the game image for each of the second game apparatuses based on the bit rate for each of the second game apparatuses.

6. The game system according to claim 1, wherein
the one or more memories of the first game apparatus store the game program and a system program,
the number or a maximum number of the second game apparatuses is defined by the game program, and
the first operations comprise setting an initial value of the bit rate based on the number or the maximum number defined by the game program currently being executed, by executing the system program.

7. The game system according to claim 1, wherein
the first operations further comprise setting a value of a VBV buffer size in the encoding based on the number of the second game apparatuses.

8. The game system according to claim 7, wherein
the setting the value of the VBV buffer size comprises setting an initial value of the VBV buffer size based on the number of the second game apparatuses, and
the value of the VBV buffer size is changed for each of the second game apparatuses based on a bit rate of a result of the encoding for each of the second game apparatuses.

9. One or more non-transitory computer-readable storage media having stored therein instructions that cause one or more processors of a game apparatus to perform operations comprising:
setting a bit rate for encoding based on the number of other game apparatuses;
receiving input data of at least one of the other game apparatuses;
executing a game program using input data of the game apparatus and the received input data;
generating a game image;
encoding of the generated game image based on the set bit rate; and
transmitting the encoded game image to the at least one of the other game apparatuses.

10. The one or more non-transitory computer-readable storage media according to claim 9, wherein
the operations further comprise determining the number of other game apparatuses at a start of a game, and
the setting is performed based on the determined number of other game apparatuses.

11. The one or more non-transitory computer-readable storage media according to claim 9, wherein
the setting is a setting of an initial value of the bit rate performed based on the number of other game apparatuses, and
in the encoding, the bit rate is varied according to a communication state of the game image.

12. The one or more non-transitory computer-readable storage media according to claim 11, wherein
the encoding further comprises varying the bit rate of a result of the encoding according to an amount of information of the game image.

13. The one or more non-transitory computer-readable storage media according to claim 11, wherein
the initial value is set in common for a plurality of other game apparatuses,
in the encoding, the bit rate is varied for each of the other game apparatuses according to the communication state for each of the other game apparatuses, and
the encoding comprises the encoding of the game image for each of the other game apparatuses based on the bit rate for each of the other game apparatuses.

14. The one or more non-transitory computer-readable storage media according to claim 9, wherein
the game apparatus further comprises one or more memories storing the game program and a system program,
the number or a maximum number of other game apparatuses is defined by the game program, and
the operations comprise setting an initial value of the bit rate based on the number or the maximum number defined by the game program currently being executed, by executing the system program.

15. The one or more non-transitory computer-readable storage media according to claim 9, wherein
the operations further comprise setting a value of a VBV buffer size in the encoding based on the number of other game apparatuses.

16. The one or more non-transitory computer-readable storage media according to claim 15, wherein
the setting the value of the VBV buffer size comprises setting an initial value of the VBV buffer size based on the number of other game apparatuses, and
the value of the VBV buffer size is changed for each of the other game apparatuses based on a bit rate of a result of the encoding for each of the other game apparatuses.

17. A computer-implemented method for controlling a game apparatus, comprising:
determining the number of other game apparatuses;
setting a bit rate for encoding based on the determined number;
receiving input data of at least one of the other game apparatuses;
executing a game program using input data of the game apparatus and the received input data;
generating a game image;
encoding of the generated game image based on the set bit rate; and
transmitting the encoded game image to the at least one of the other game apparatuses.

18. The computer-implemented method according to claim 17, wherein
the setting comprises setting an initial value of the bit rate based on the number of other game apparatuses, and
in the encoding, the bit rate is varied according to a communication state of the game image.

19. The computer-implemented method according to claim 18, wherein
the encoding further comprises varying the bit rate of a result of the encoding according to an amount of information of the game image.

20. The computer-implemented method according to claim 18, wherein
the initial value is set in common for a plurality of other game apparatuses,
in the encoding, the bit rate is varied for each of the other game apparatuses according to the communication state for each of the other game apparatuses, and
the encoding comprises the encoding of the game image for each of the other game apparatuses based on the bit rate for each of the other game apparatuses.
